(19) United States
(12) Patent Application Publication
(10) Pub. No.: US 2025/0097857 A1
(43) Pub. Date: Mar. 20, 2025

(54) TRANSMIT POWER CONTROL OF SIDELINK CHANNELS ON MULTIPLE CARRIERS

(71) Applicant: Samsung Electronics Co., Ltd., Suwon-si (KR)

(72) Inventors: Carmela Cozzo, San Diego, CA (US); Emad Nader Farag, Flanders (V); Hongbo Si, Allen, TX (US)

(21) Appl. No.: 18/820,150

(22) Filed: Aug. 29, 2024

Related U.S. Application Data
(60) Provisional application No. 63/538,974, filed on Sep. 18, 2023.
(60) Provisional application No. 63/541,652, filed on Sep. 29, 2023.

(51) Int. Cl. H04W 52/34; H04W 52/24; H04W 52/36; H04W 72/25

(52) U.S. Cl. CPC H04W 52/34; H04W 52/242; H04W 52/367; H04W 72/25

(57) ABSTRACT

Methods and apparatuses for transmit power control of sidelink (SL) channels on multiple carriers in a wireless communication system. A method of a user equipment (UE) includes receiving information related to SL operation on multiple SL carriers and simultaneous transmissions of a physical SL feedback channel (PSFCH) and a physical SL control or shared channel (PSCCH or PSSCH) and determining first and second powers for simultaneous transmissions of the PSFCH on first carriers and the PSCCH or PSSCH on second carriers. The first powers are based on values of a power control parameter associated with the first carriers. A sum of the second powers does not exceed a power difference between a maximum power and a sum of the first powers. The method further includes simultaneously transmitting the PSFCH on the first carriers using the first powers and the PSCCH or PSSCH on the second carriers using the second powers.

### CROSS-REFERENCE TO RELATED APPLICATIONS AND CLAIM OF PRIORITY

The present application claims priority to U.S. Provisional Patent Application No. 63/538,974 filed on Sep. 18, 2023, and U.S. Provisional Patent Application No. 63/541,652 filed on Sep. 29, 2023. The contents of the above-identified patent documents are incorporated herein by reference.

### TECHNICAL FIELD

The present disclosure relates generally to wireless communication systems and, more specifically, the present disclosure relates to transmit power control of sidelink (SL) channels on multiple carriers in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to transmit power control of SL channels on multiple carriers in a wireless communication system.

In one embodiment, a user equipment (UE) in a wireless communication system is provided. The UE includes a transceiver configured to receive information related to SL operation on multiple SL carriers and simultaneous transmissions of one or more physical SL feedback channel (PSFCHs) and one or more physical SL control or shared channels (PSCCHs or PSSCHs). The UE further includes a processor operably coupled to the transceiver. The processor is configured to determine first powers and second powers for simultaneous transmissions of the one or more PSFCHs on first carriers and the one or more PSCCHs or PSSCHs on second carriers. The first powers are based on values of a first power control parameter associated with the first carriers. A sum of the second powers does not exceed a power difference between a maximum power and a sum of the first powers. The transceiver is further configured to simultaneously transmit (i) the one or more PSFCHs on the first carriers using the first powers and (ii) the one or more PSCCHs or PSSCHs on the second carriers using the second powers.

In another embodiment, a method of UE in a wireless communication system is provided. The method includes receiving information related to SL operation on multiple SL carriers, and simultaneous transmissions of one or more PSFCHs and one or more PSCCH or PSSCHs and determining first powers and second powers for simultaneous transmissions of the one or more PSFCHs on first carriers and the one or more PSCCHs or PSSCHs on second carriers. The first powers are based on values of a first power control parameter associated with the first carriers. A sum of the second powers does not exceed a power difference between a maximum power and a sum of the first powers. The method further includes simultaneously transmitting (i) the one or more PSFCHs on the first carriers using the first powers and (ii) the one or more PSCCHs or PSSCHs on the second carriers using the second powers.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4A and 4B illustrate an example of wireless transmit and receive paths according to this disclosure;

FIG. 5 illustrates an example of a transmitter structure for beamforming according to embodiments of the present disclosure;

FIG. 6 illustrates an example of a layer-2 link establishment procedure for a unicast mode of V2X communication over PC5 reference point according to embodiments of the present disclosure;

FIG. 7 illustrates an example of a time domain resource determination for PSFCH according to embodiments of the present disclosure;

FIG. 8 illustrates an example of UE configured for a SL operation on two carriers according to embodiments of the present disclosure;

FIG. 9 illustrates another example of UE configured for a SL operation on two carriers according to embodiments of the present disclosure;

FIG. 10 illustrates yet another example of UE configured for a SL operation on two carriers according to embodiments of the present disclosure;

FIG. 11 illustrates a flowchart of a UE method for determining a power for a transmission of a PSSCH and PSFCHs that overlap in a time domain according to embodiments of the present disclosure;

FIG. 12 illustrates a flowchart of a UE method for determining a power for a transmission of PSFCHs and PSCCHs/PSSCHs that overlap in a time domain over multiple carriers according to embodiments of the present disclosure; and

FIG. 13 illustrates a flowchart of a UE method to determine a power for a transmission of PSFCHs and PSCCHs/PSSCHs that overlap in time over multiple carriers when the UE is provided a P_{CMAX} according to embodiments of the present disclosure.

### DETAILED DESCRIPTION

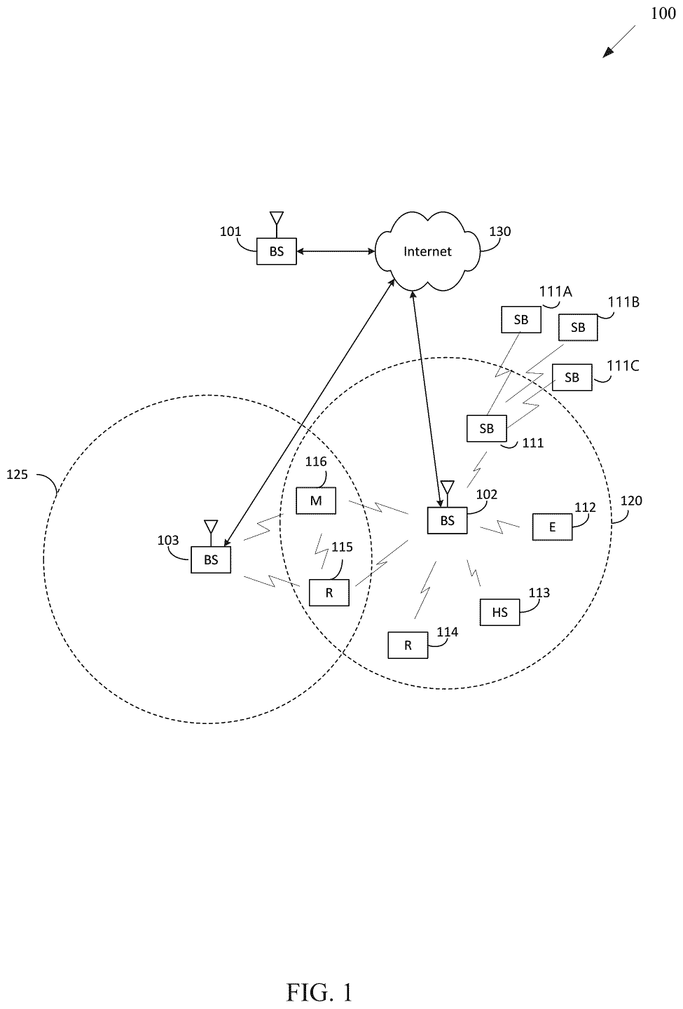

FIGS. 1-13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v17.6.0, “NR; Physical channels and modulation”; 3GPP TS 38.212 v17.6.0, “NR; Multiplexing and channel coding”; 3GPP TS 38.213 v17.6.0, “NR; Physical layer procedures for control”; 3GPP TS 38.214 v17.6.0, “NR; Physical layer procedures for data”; 3GPP TS 38.321 v17.5.0, “NR; Medium Access Control (MAC) protocol specification”; 3GPP TS 38.331 v17.5.0, “NR; Radio Resource Control (RRC) protocol specification” and 3GPP TS 36.213 v17.4.0, “Evolved Universal Terrestrial Radio Access (E-UTRA); Physical layer procedures.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for transmit power control of SL channels on multiple carriers in a wireless communication system. In certain embodiments, and one or more of the gNBs 101-103 includes circuitry, programing, or a combination thereof, for supporting transmit power control of SL channels on multiple carriers in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

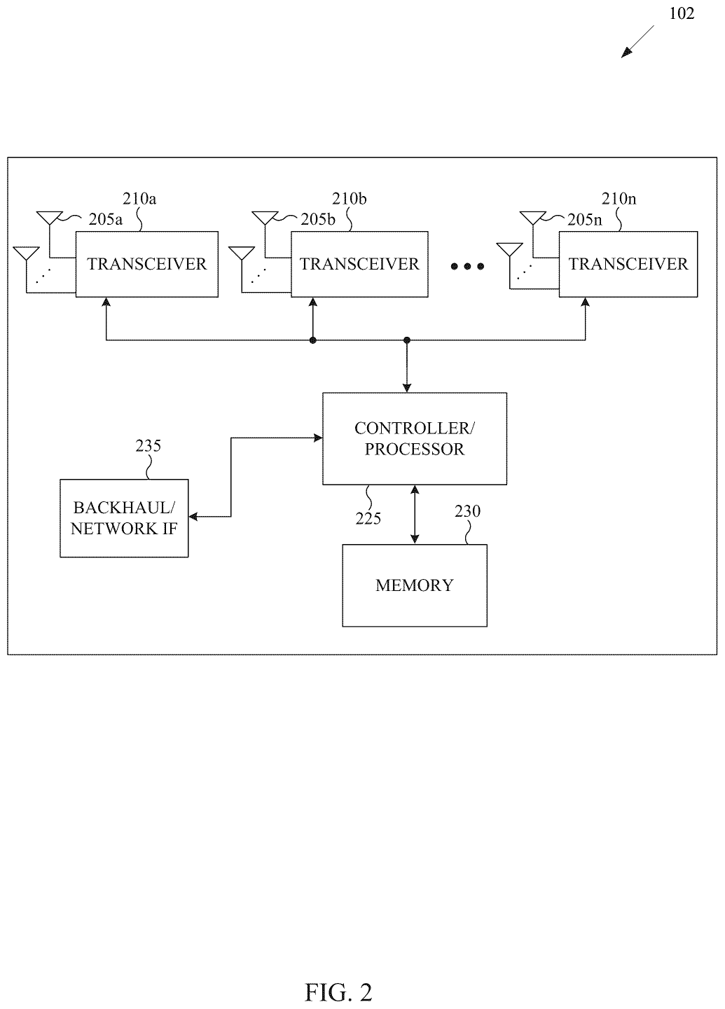

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting transmit power control of SL channels on multiple carriers in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

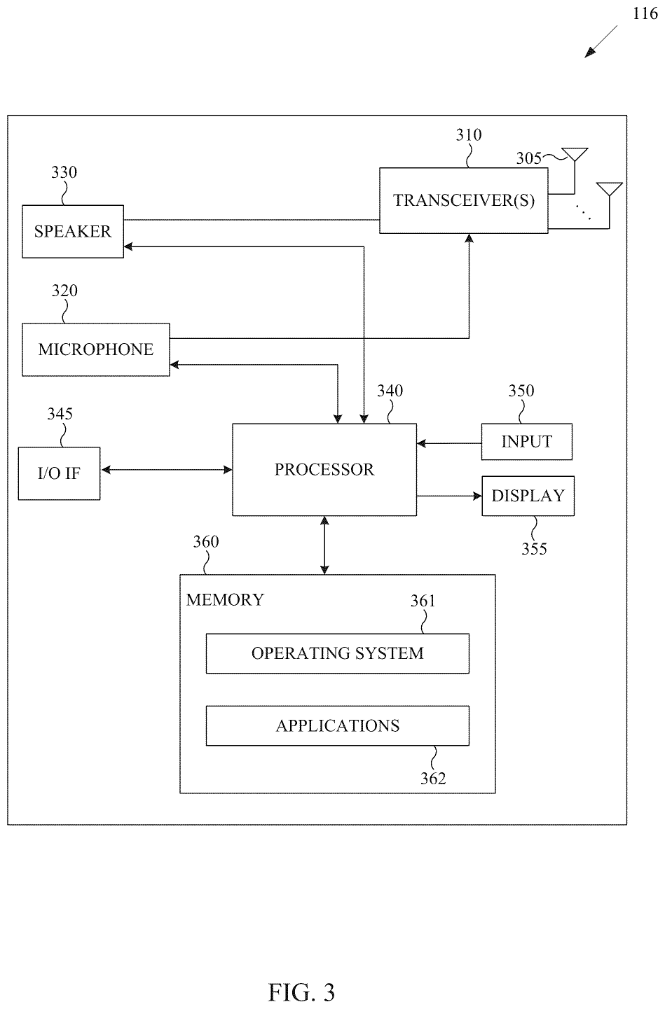

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for transmit power control of SL channels on multiple carriers in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

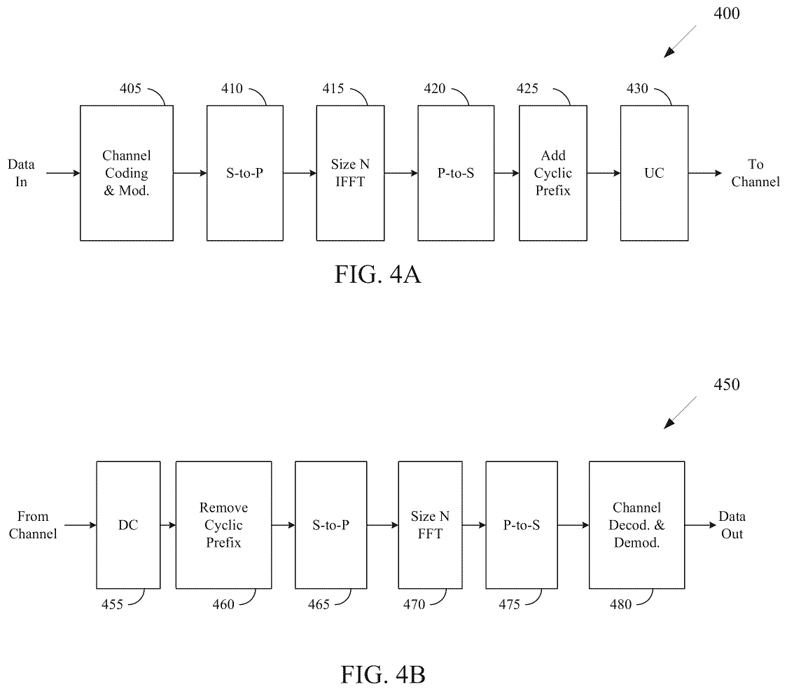

FIG. 4A and FIG. 4B illustrate example wireless transmit and receive paths according to this disclosure. In the following description, a transmit path 400 may be described as being implemented in a gNB (such as the gNB 102), while a receive path 450 may be described as being implemented in a UE (such as a UE 116). However, it may be understood that the receive path 450 can be implemented in a gNB and that the transmit path 400 can be implemented in a UE. In various embodiments, the receive path 450 can be implemented in a first UE and the transmit path 400 can be implemented in a second UE. In some embodiments, the receive path 450 is configured to support transmit power control of SL channels on multiple carriers in a wireless communication system.

The transmit path 400 as illustrated in FIG. 4A includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 450 as illustrated in FIG. 4B includes a down-converter (DC) 455, a remove cyclic prefix block 460, a serial-to-parallel (S-to-P) block 465, a size N fast Fourier transform (FFT) block 470, a parallel-to-serial (P-to-S) block 475, and a channel decoding and demodulation block 480.

As illustrated in FIG. 4A, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 4B, the down converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time domain signals. The size N FFT block 470 performs an FFT algorithm to generate N parallel frequency-domain signals. The parallel-to-serial block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 as illustrated in FIG. 4A that is analogous to transmitting in the downlink to UEs 111-116 and may implement a receive path 450 as illustrated in FIG. 4B that is analogous to receiving in the uplink from UEs 111-116. Similarly, each of UEs 111-116 may implement the transmit path 400 for transmitting in the uplink to the gNBs 101-103 and may implement the receive path 450 for receiving in the downlink from the gNBs 101-103.

Each of the components in FIG. 4A and FIG. 4B can be implemented using only hardware or using a combination of hardware and software/firmware. As a particular example, at least some of the components in FIG. 4A and FIG. 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4A and FIG. 4B illustrate examples of wireless transmit and receive paths, various changes may be made to FIG. 4A and FIG. 4B. For example, various components in FIG. 4A and FIG. 4B can be combined, further subdivided, or omitted and additional components can be added according to particular needs. Also, FIG. 4A and FIG. 4B are meant to illustrate examples of the types of transmit and receive paths that can be used in a wireless network. Any other suitable architectures can be used to support wireless communications in a wireless network.

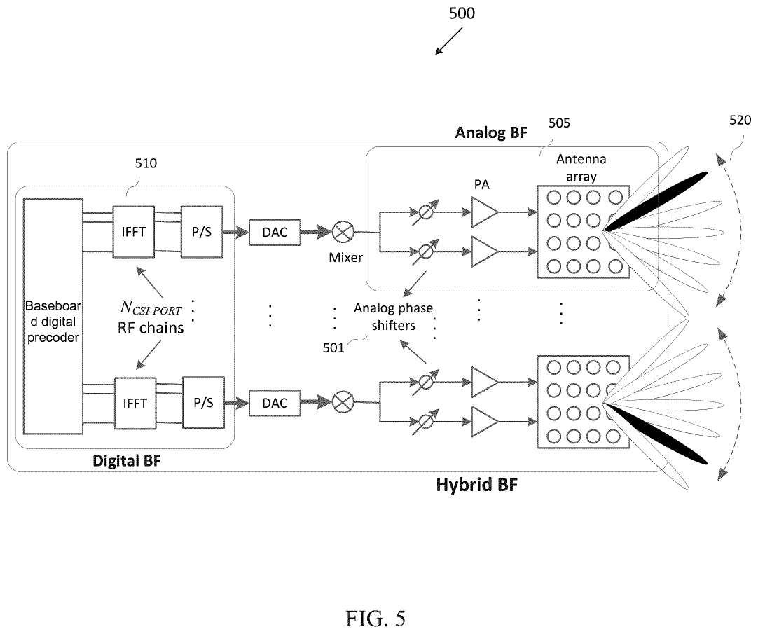

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCSI-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

When a UE is configured for a SL operation on multiple carriers, a procedure for resource allocation for transmissions on each carrier of the multiple carriers can jointly or independently allocate resources on some or all of the multiple carriers.

In one example, the procedure for resource allocation on each carrier of the multiple carriers ensures that resources for PSCCHs, PSSCHs, and PSFCHs are aligned in a time over the multiple carriers, and an overlap in a time of transmissions on different carriers may involve transmissions of a same channel. For example, in some or all of the multiple carriers, the overlap in a time may happen between transmissions of PSCCHs only, PSSCHs only, or PSFCHs only.

In one example, the procedure for resource allocation on each carrier of the multiple carriers does not ensure that resources for PSCCHs, PSSCHs, and PSFCHs are aligned in a time over the multiple carriers, and an overlap in time of transmissions on different carriers may involve transmissions of more than one channel. For example, in some or all of the multiple carriers, the overlap in a time may happen between transmissions of PSCCHs, PSSCHs, and PSFCHs.

When a UE is configured for a SL operation on multiple carriers, whether the procedure for resource allocation for transmission on each carrier of the multiple carriers has restrictions to ensure that resources for transmissions for a same channel are aligned in a time over the multiple carriers (or equivalently, joint SL resource allocation in time domain over the multiple carriers) or not (or equivalently, separate SL resource allocation in time domain for the multiple carriers), can be subject to a configuration.

If the UE is configured with joint SL resource allocation in a time domain over the multiple carriers and an overlap in a time among transmissions of PSCCHs, PSSCHs, or PSFCHs, may occur, the UE may transmit the PSCCHs, the PSSCHs, or the PSFCHs, according to the procedures described above.

If the UE is configured with a separate SL resource allocation without aligned time resources over the multiple carriers, an overlap in a time between transmissions of different channels may occur. Thus, the UE needs to determine the powers for the transmissions of the different channels on the multiple carriers based on at least a total power for the transmission of the different channels, priorities associated with the different channels, a configuration and UE capabilities.

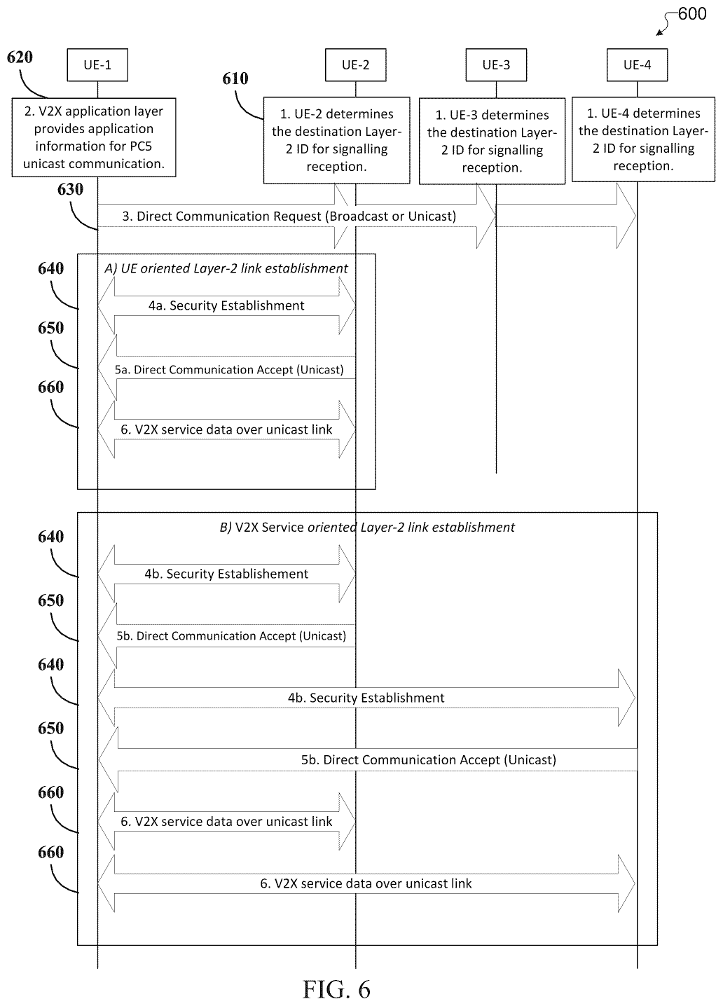

FIG. 6 illustrates a flowchart of an example process 600 for a layer-2 link establishment for unicast mode of V2X communication over PC5 reference point according to embodiments of the present disclosure. For example, process 600 can be performed by multiple of the UEs 111-116 of FIG. 1 to perform SL communications. This example is for illustration only and other embodiments can be used without departing from the scope of the present disclosure.

Process 600 begins in step 610, the UE(s) determine the destination Layer-2 ID for signaling reception of PC5 unicast link establishment. This is determined as specified in clause 5.6.1.4 of TS 23.387. The destination Layer-2 ID is configured with the UE(s) as specified in clause 5.1.2.1 of TS 23.387. In step 620, the V2X application layer in UE-1 provides application information for PC5 unicast communicating. In step 630, UE-1 sends a Direct Communication Request (DCR) to initiate the unicast layer-2 link establishment procedure and sends the DCR message via PC5 broadcast or unicast using the source Layer-2 ID and destination Layer-2 ID. In step 640, the target UE, or the UEs that are interested in using the announced V2X service type(s) over a PC5 unicast link with UE-1, responds which establishes the security with UE-1. In step 650, the target UE(s) that has successfully established security with UE-1 sends a direct communication accept message to UE-1. In step 660, V2X service data is transmitted over the established unicast link.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1).

In addition, a slot can have symbols for SL communications. A UE can be configured one or more bandwidth parts (BWPs) of a system BW for transmissions or receptions of signals or channels.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information and second stage/part SL control information (SCI), physical SL control channels (PSCCHs) conveying first stage/part SCI for scheduling transmissions/receptions of PSSCHs, physical SL feedback channels (PSFCHs) conveying hybrid automatic repeat request acknowledgement (HARQ-ACK) information in response to correct (ACK value) or incorrect (NACK value) transport block receptions in respective PSSCHs, and physical SL broadcast channel (PSBCH) conveying system information to assist in SL synchronization.

SL signals include demodulation reference signals DM-RS that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization. SCI can include two parts/stages corresponding to two respective SCI formats where, for example, the first SCI format is multiplexed on a PSCCH, and the second SCI format is multiplexed along with SL data on a PSSCH that is transmitted in physical resources indicated by the first SCI format.

A transport block (TB) is carried in a PSSCH. The SCI indicates the resources used by the PSSCH that carries the associated TB, as well as further information required for decoding the TB. A PSCCH is sent with a PSSCH. The SCI is transmitted in two stages: 1st-stage SCI is carried on the PSCCH and 2nd-stage SCI is carried on the corresponding PSSCH, and such flexible SCI design can support unicast, groupcast, and broadcast transmissions. Splitting the SCI in two stages (1st-stage SCI and 2nd-stage SCI) allows other UEs which are not RX UEs of a transmission to decode only the 1st-stage SCI for channel sensing purposes, i.e., for determining the resources reserved by other transmissions. On the other hand, the 2nd-stage SCI provides additional control information which is required for the RX UE(s) of a transmission.

A SL channel can operate in different cast modes. In a unicast mode, a PSCCH/PSSCH conveys SL information from one UE to only one other UE. In a groupcast mode, a PSCCH/PSSCH conveys SL information from one UE to a group of UEs within a (pre-) configured set. In a broadcast mode, a PSCCH/PSSCH conveys SL information from one UE to all surrounding UEs. In NR Release 16, there are two resource allocation modes for a PSCCH/PSSCH transmission.

In resource allocation mode 1, a gNB schedules a UE on the SL and conveys scheduling information to the UE transmitting on the SL through a DCI format (e.g., DCI Format 3_0) transmitted from the gNB on the DL. In resource allocation mode 2, a UE schedules a SL transmission. SL transmissions can operate within network coverage where each UE is within the communication range of a gNB, outside network coverage where all UEs have no communication with any gNB, or with partial network coverage, where only some UEs are within the communication range of a gNB.

In case of groupcast PSCCH/PSSCH transmission, a network can configure a UE one of two options for reporting of HARQ-ACK information by the UE: Option (1) of HARQ-ACK reporting option: a UE can attempt to decode a transport block (TB) in a PSSCH reception if, for example, the UE detects a SCI format scheduling the TB reception through a corresponding PSSCH. If the UE fails to correctly decode the TB, the UE multiplexes a negative acknowledgement (NACK) in a PSFCH transmission. In this option, the UE does not transmit a PSFCH with a positive acknowledgment (ACK) when the UE correctly decodes the TB; and Option (2) HARQ-ACK reporting option: a UE can attempt to decode a TB if, for example, the UE detects a SCI format that schedules a corresponding PSSCH. If the UE correctly decodes the TB, the UE multiplexes an ACK in a PSFCH transmission; otherwise, if the UE does not correctly decode the TB, the UE multiplexes a NACK in a PSFCH transmission.

In HARQ-ACK reporting option (1), when a UE that transmitted the PSSCH detects a NACK in a PSFCH reception, the UE can transmit another PSSCH with the TB (retransmission of the TB). In HARQ-ACK reporting option (2) when a UE that transmitted the PSSCH does not detect an ACK in a PSFCH reception, such as when the UE detects a NACK or does not detect a PSFCH reception, the UE can transmit another PSSCH with the TB.

A SL resource pool includes a set/pool of slots and a set/pool of RBs used for SL transmission and SL reception. A set of slots which belong to a SL resource pool can be denoted by {t′₀^{SL}, t′₁^{SL}, t′₂^{SL}, . . . , t′_{T′}_{_{MAX}}₋₁^{SL}} and can be configured, for example, at least using a bitmap. Where, T′_{MAX} is the number of SL slots in a resource pool within 1024 frames. Within each slot t′_{y}^{SL} of a SL resource pool, there are N_{subCH} contiguous sub-channels in the frequency domain for SL transmission, where N_{subCH} is provided by a higher-layer parameter. Subchannel m, where m is between 0 and N_{subCH}−1, is given by a set of n_{subCHsize} contiguous PRBs, given by n_{PRB}=n_{subCHstart}+m·n_{subCHsize}+j, where j=0, 1, . . . , n_{subCHsize}−1, n_{subCHstart} and n_{subCHsize} are provided by higher layer parameters.

For resource (re-)selection or re-evaluation in slot n, a UE can determine a set of available single-slot resources for a transmission within a resource selection window [n+T₁, n+T₂], such that a single-slot resource for a transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤T_{proc,1}^{SL}, where T_{proc,1}^{SL} is a PSSCH processing time for example as defined in 3GPP standard specification TS 38.214. T₂ is determined by the UE such that T₂ₘᵢₙ≤T₂≤remaining packet delay budget, as long as T₂ₘᵢₙ<remaining packet delay budget, else T₂ is equal to the remaining packet delay budget. T₂ₘᵢₙ is a configured by higher layers and depends on the priority of the SL transmission.

The slots of a SL resource pool are determined as shown in TABLE 1.

TABLE 1
Slot of SL resource pool

```
1. Let set of slots that may belong to a resource be denoted by {t₀^{SL}, t₁^{SL}, t₂^{SL}, ... , t_{T}_{_{MAX}}₋₁^{SL}},
  where 0 ≤ tᵢ^{SL} < 10240 × 2^{μ}, and 0 ≤ i < Tₘₐₓ. μ is the sub-carrier spacing configuration.
  μ = 0 for a 15 kHz sub-carrier spacing. μ = 1 for a 30 kHz sub-carrier spacing. μ = 2 for a
  60 kHz sub-carrier spacing. μ = 8 for a 120 kHz sub-carrier spacing. The slot index is
  relative to slot#0 of SFN#0 of the serving cell, or DFN#0. The set of slots includes all
  slots except:
    a. N_{S-SSB} slots that are configured for SL SS/PBCH block (S-SSB).
    b. N_{nonSL} slots where at least one SL symbol is not semi-statically configured as UL
      symbol by higher layer parameter tdd-UL-DL-ConfigurationCommon or sl-TDD-
      Configuration. In a SL slot, OFDM symbols Y-th, (Y + 1)-th, .... , (Y + X − 1)-th are
      SL symbols, where Y is determined by the higher layer parameter sl-StartSymbol and
      X is determined by higher layer parameter sl-LengthSymbols.
    c. N_{reserved} reserved slots. Reserved slots are determined such that the slots in the set
      {t₀^{SL}, t₁^{SL}, t₂^{SL}, ... , t_{T}_{_{MAX}}₋₁^{SL}} is a multiple of the bitmap length (L_{bitmap}), where the
      bitmap (b₀, b₁, ... , b_{L}_{_{bitmap}}₋₁) is configured by higher layers. The reserved slots are
      determined as follows:
        i. Let {l₀, 1₁, ... , l₂_{^{μ}}_{×10240-N}_{_{S-SSB}}_{-N}_{_{nonSL}}₋₁} be the set of slots in range 0 ...
          2^{μ} × 10240 − 1, excluding S-SSB slots and non-SL slots. The slots are
          arranged in ascending order of the slot index.
        ii. The number of reserved slots is given by: N_{reserved} = (2μ × 10240 −
          N_{S-SSB} − N_{nonSL}) mod L_{bitmap}.
        $iii . The reserved slots {l}_{r} are given by : r = ⌊ \frac{m \cdot ( {2}^{μ} \times 10240 - {N}_{S - SSB} - {N}_{n o n S L} )}{{N}_{r e s e r v e d}} ⌋ ,$
            where m = 0, 1, ... , N_{reserved} − 1
  Tₘₐₓ is given by: Tₘₐₓ = 2^{μ} × 10240 − N_{S-SSB} − N_{nonSL} − N_{reserved} .
2. The slots are arranged in ascending order of slot index.
3. The set of slots belonging to the SL resource pool, {t₀^{′SL}, t₁^{′SL}, t₂^{′SL}, ... , t_{T}_{_{MAX}}₋₁^{′SL}}, are
  determined as follows:
    a. Each resource pool has a corresponding bitmap (b₀, b₁, ... , b_{L}_{_{bitmap}}₋₁) of length
      L_{bitmap}.
    b. A slot tₖ^{SL} belongs to the SL resource pool if b_{k mod L}_{_{bitmap}} = 1
    c. The remaining slots are indexed successively staring from 0, 1, ... T_{MAX}′ − 1.
      Where, T_{MAX}′ is the number of remaining slots in the set.
```

Slots can be numbered (indexed) as physical slots or logical slots, wherein physical slots include all slots numbered sequential, while logical slots include only slots that can be allocated to SL resource pool as described above numbered sequentially. The conversion from a physical duration, Pᵣₛᵥₚ, in milli-second to logical slots, Pᵣₛᵥₚ′, is given by

$${P}_{rsvp}^{′} = ⌈ \frac{{T}_{max}^{′}}{10240 ms} \times {P}_{rsvp} ⌉$$

(as illustrated in 3GPP standard specification 38.214).

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤T_{proc,1}^{SL}, where T_{proc,1}^{SL} is a PSSCH processing time for example as defined in 3GPP standard specification TS 38.214. T₂ is determined by the UE such that T₂ₘᵢₙ≤T₂≤remaining packet delay budget, as long as T₂ₘᵢₙ<remaining packet delay budget, else T₂ is equal to the remaining packet delay budget. T₂ₘᵢₙ is configured by higher layers and depends on the priority of the SL transmission.

The resource (re-)selection is a two-step procedure: (1) the first step (e.g., performed in the physical layer) is to identify the candidate resources within a resource selection window. Candidate resources are resources that belong to a resource pool, but exclude resources (e.g., resource exclusion) that were previously reserved, or potentially reserved by other UEs. The resources excluded are based on SCIs decoded in a sensing window and for which the UE measures a SL RSRP that exceeds a threshold. The threshold depends on the priority indicated in a SCI format and on the priority of the SL transmission. Therefore, sensing within a sensing window involves decoding the first stage SCI, and measuring the corresponding SL RSRP, wherein the SL RSRP can be based on PSCCH DM-RS or PSSCH DM-RS. Sensing is performed over slots where the UE does not transmit SL. The resources excluded are based on reserved transmissions or semi-persistent transmissions that can collide with the excluded resources or any of reserved or semi-persistent transmissions. The identified candidate resources after resource exclusion are provided to higher layers; and (2) the second step (e.g., performed in the higher layers) is to select or re-select a resource from the identified candidate resources for PSSCH/PSCCH transmission.

During the first step of the resource (re-)selection procedure, a UE can monitor slots in a sensing window [n−T₀, n−T_{proc,0}^{SL}), where the UE monitors slots belonging to a corresponding SL resource pool that are not used for the UE's own transmission. For example, T_{proc,0}^{SL} is the sensing processing latency time, for example as defined in 3GPP standard specification TS 38.214. To determine a candidate single-slot resource set to report to higher layers, a UE excludes (e.g., resource exclusion) from the set of available single-slot resources for SL transmission within a resource pool and within a resource selection window, as shown in TABLE 2.

```
TABLE 2
1. Single slot resource R_{x,y}, such that for any slot tₘ′^{sL} not monitored within the sensing
  window with a hypothetical received SCI Format 1-0, with a “Resource reservation
  period” set to any periodicity value allowed by a higher layer parameter reservation
  PeriodAllowed, and indicating all sub-channels of the resource pool in this slot,
  satisfies condition 2.2. below.
2. Single slot resource R_{x,y}, such that for any received SCI within the sensing window:
    1. The associated L1-RSRP measurement is above a (pre-)configured SL-RSRP
      threshold, where the SL-RSRP threshold depends on the priority indicated in the
      received SCI and that of the SL transmission for which resources are being
      selected.
    2. (Condition 2.2) The received SCI in slot tₘ′^{SL}, or if “Resource reservation field”
      is present in the received SCI the same SCI is assumed to be received in slot
      ${t}_{m + q \times {P}_{rsvp \_ Rx}^{′}}^{′ S L} , indicates a set of resource blocks that overlaps$
      ${R}_{x , y + j \times {P}_{rsvp \_ Tx}^{′}} .$
      Where,
        q = 1,2, ... , Q, where,
          $If {P}_{rsvp\_RX} \leq {T}_{scal} and {n}^{′} - m < {P}_{rsvp \_ Rx}^{′} \to Q = ⌈ \frac{{T}_{s c a l}}{{P}_{rsvp \_ RX}} ⌉ .$
            T_{scal} is T₂ in units of milli-seconds.
            Else Q = 1
            $If n belongs to ( {t}_{0}^{′ S L} , {t}_{1}^{′ S L} , … , {t}_{{T}_{max}^{′} - 1}^{′ S L} ) , {n}^{′} = n , else {n}^{′} is the first$
            $slot after slot n belonging to set ( {t}_{0}^{′ S L} , {t}_{1}^{′ S L} , … , {t}_{{T}_{max}^{′} - 1}^{′ S L} ) .$
        j = 0, 1, ... , Cᵣₑₛₑₗ − 1
        Pᵣₛᵥₚ_RX is the indicated resource reservation period in the received SCI in
        physical slots, and Pᵣₛᵥₚ_Rx′ is that value converted to logical slots.
        Pᵣₛᵥₚ_Tx′ is the resource reservation period of the SL transmissions for which
        resources are being reserved in logical slots.
3. If the candidate resources are less than a (pre-)configured percentage given by higher
  layer parameter sl_TxPercentageList(prio_{TX}) that depends on the priority of the SL
  transmission prio_{TX}, such as 20%, of the total available resources within the resource
  selection window, the (pre-)configured SL-RSRP thresholds are increased by a
  predetermined amount, such as 3 dB.
```

An NR SL introduced two new procedures for mode 2 resource allocation; re-evaluation and pre-emption.

A re-evaluation check occurs when a UE checks the availability of pre-selected SL resources before the resources are first signaled in an SCI format, and if needed re-selects new SL resources. For a pre-selected resource to be first-time signaled in slot m, the UE performs a re-evaluation check at least in slot m−T₃.

The re-evaluation check includes: (1) performing the first step of the SL resource selection procedure as defined in the 3GPP specifications TS 38.214, which involves identifying a candidate (available) SL resource set in a resource selection window as previously described; and (2) if the pre-selected resource is available in the candidate SL resource set, the resource is used/signaled for SL transmission; and (3) else, the pre-selected resource is not available in the candidate SL resource set, a new SL resource is re-selected from the candidate SL resource set.

A pre-emption check occurs when a UE checks the availability of pre-selected SL resources that have been previously signaled and reserved in an SCI Format, and if needed re-selects new SL resources. For a pre-selected and reserved resource to be signaled in slot m, the UE performs a pre-emption check at least in slot m−T₃.

When pre-emption check is enabled by higher layers, pre-emption check includes: (1) performing the first step of the SL resource selection procedure as defined in the 3GPP standard specifications TS 38.214, which involves identifying candidate (available) SL resource set in a resource selection window as previously described; (2) if the pre-selected and reserved resource is available in the candidate SL resource set, the resource is used/signaled for SL transmission; and (3) else, the pre-selected and reserved resource is NOT available in the candidate SL resource set. The resource is excluded from the candidate resource set due to an SCI, associated with a priority value P_{RX}, having an RSRP exceeding a threshold. Let the priority value of the SL resource being checked for pre-emption be P_{TX}: (i) if the priority value P_{RX} is less than a higher-layer configured threshold and the priority value P_{RX} is less than the priority value P_{TX}. The pre-selected and reserved SL resource is pre-empted. A new SL resource is re-selected from the candidate SL resource set. Note that, a lower priority value indicates traffic of higher priority; and (ii) else, the resource is used/signaled for SL transmission.

For SL transmissions, an open-loop power control scheme can be used, and a receiving UE does not inform a transmitting UE to increase or decrease the transmission power level. In a first example the receiving UE can measure an RSRP of a reference signal, for example a DM-RS on a PSSCH, and report the measurement through higher layer signaling to the transmitting UE that can estimate a pathloss of the SL transmissions. In a second example the transmitting UE estimates the SL pathloss used to determine the power of the SL transmissions to be received by the receiving UE from measurements of a reference signal transmitted by the receiving UE. In a third example the transmitting UE estimates the SL pathloss using both RSRP measurements of the first and second examples.

To determine the transmission power, based on a configuration the transmitting UE can use only the downlink pathloss (between transmitting UE and gNB), only the SL pathloss (between transmitting UE and receiving UE), or both downlink pathloss and SL pathloss. The configuration can be the same for PSSCH, PSSCH and PSFCH, resulting in the same power for all symbols used for PSSCH, PSSCH and PSFCH in a slot, or can be different.

For example, a first configuration to use both the SL pathloss and the downlink pathloss can apply to the transmit power control of PSSCH and PSCCH, and a second configuration to use the downlink pathloss can apply to the transmit power control of PSFCH. For the UE configured to use both downlink pathloss and SL pathloss to determine the transmission power of the SL channel(s), the transmission power can be determined as the minimum (or the maximum) value among the SL transmission power derived from the SL pathloss, and the downlink transmission power derived from the downlink pathloss.

In one example, a UE determines a power, P_{S-SSB}(i), in dBm, for an S-SS/PSBCH block (S-SSB) transmission occasion in slot i on an active SL BWP b of a carrier f, as: P_{S-SSB}(i)=min(P_{CMAX},P_{O,S-SSB}+10 log₁₀(2^{μ}·M_{RB}^{S-SSB})+α_{S-SSB}·PL).

In such example, following parameters are defined as shown in TABLE 3.

TABLE 3
Definition of parameters

P_{CMAX} is the configured maximum output power of the UE.
P_{O, S-SSB} is the P0 value for DL pathloss based power control for PSBCH. If dl-P0-PSBCH-
r17 is configured and supported by the UE it is used for P_{O, S-SSB}, else if dl-P0-PSBCH-r16
is configured it is used for P_{O, S-SSB}, else DL pathloss based power control for PSBCH is
disabled, i.e., P_{S-SSB} (i) = P_{CMAX}.
dl-P0-PSFCH-r16 has a range of −16 . . . 15
dl-P0-PSFCH-r17 has a range of −202 . . . 24
μ is the sub-carrier spacing configuration.
M_{RB}^{S-SSB} is the number of resource blocks for S-SS/PSBCH block transmission. M_{RB}^{S-SSB} =
11.
α_{S-SSB} is the alpha value for DL pathloss based power control for PSBCH. This is provided
by higher layer parameter dl-Alpha-PSBCH-r16, and is 1 if that parameter is not configured.
dl-Alpha-PSBCH-r16 is a value from the set {0, 0.4, 0.5, 0.6, 0.7, 0.8 ,0.9, 1}.
PL is the pathloss, which is given by PL = PL_{b, f ,c}(q_{d}) when the active SL BWP is on
serving cell c. The RS resource q_{d} for determining the pathloss is given by:
When the UE is configured to monitor PDCCH for detection of DCI Format 0_0 in
serving cell c: RS resource used for determining the power of a PUSCH transmission
scheduled by DCI Format 0_0 in serving cell c.
When the UE is not configured to monitor PDCCH for detection of DCI Format 0_0
in serving cell c: RS resource corresponding to SS/PBCH block used by the UE to
obtain the MIB.

In one example, a UE determines a power, P_{PSSCH}(i), in dBm, for a PSSCH transmission occasion i of a resource pool, on an active SL BWP b of a carrier f, and in symbols where PSCCH is not transmitted as: P_{PSSCH}(i)=min(P_{CMAX},P_{MAX,CBR},min(P_{PSSCH,D}(i),P_{PSSCH,SL}(i)).

In such example, following parameters are defined as shown in TABLE 4.

TABLE 4
Definition of parameters

P_{CMAX} is the configured maximum output power of the UE.
P_{MAX, CBR} is determined based on the priority level and the CBR range for a CBR measured
in slot i − N. Where, N is the congestion control processing time [TS 38.214].
P_{PSSCH, D}(i) is the component for DL based power control for PSSCH. Which is given by:
If dl-P0-PSSCH-PSCCH is provided: P_{PSSCH, D}(i) = P_{O, D} + 10 log₁₀ (2^{μ} ·
M_{RB}^{PSSCH}(i)) + α_{D} · PL_{D}
If dl-P0-PSSCH-PSCCH is not provided: P_{PSSCH, D}(i) = min(P_{CMAX}, P_{MAX, CBR})
P_{O, D} is the P0 value for DL pathloss based power control for PSSCH/PSCCH. If dl-
P0-PSSCH-PSCCH-r17 is configured and supported by the UE it is used for P_{O, D},
else if dl-P0-PSSCH-PSCCH-r16 is configured it is used for P_{O, D}, else DL pathloss
based power control for PSSCH/PSCCH is disabled.
dl-P0-PSSCH-PSCCH-r16 has a range of −16 . . . 15
dl-P0-PSSCH-PSCCH-r17 has a range of −202 . . . 24
μ is the sub-carrier spacing configuration.
M_{RB}^{PSSCH}(i) is the number of resource blocks for PSSCH transmission occasion i.
α_{D} is the alpha value for DL pathloss based power control for PSSCH/PSCCH. This
is provided by higher layer parameter dl-Alpha-PSSCH-PSCCH-r16, and is 1 if that
parameter is not configured. dl-Alpha-PSSCH-PSCCH-r16 is a value from the set
{0, 0.4, 0.5, 0.6, 0.7, 0.8, 0.9, 1}.
PL_{D} is the DL pathloss, which is given by PL_{D} = PL_{b, f, c}(q_{d}) when the active SL
BWP is on serving cell c. The RS resource q_{d} for determining the pathloss is given
by:
When the UE is configured to monitor PDCCH for detection of DCI Format
0_0 in serving cell c: RS resource used for determining the power of a
PUSCH transmission scheduled by DCI Format 0_0 in serving cell c.
When the UE is not configured to monitor PDCCH for detection of DCI
Format 0_0 in serving cell c: RS resource corresponding to SS/PBCH block
used by the UE to obtain the MIB.
P_{PSSCH, SL}(i) is the component for SL based power control for PSSCH. Which is given by:
If sl-P0-PSSCH-PSCCH is provided: P_{PSSCH, SL}(i) = P_{O, SL} + 10 log₁₀ (2^{μ} ·
M_{RB}^{PSSCH}(i)) + α_{SL} · PL_{SL}
If sl-P0-PSSCH-PSCCH is not provided: P_{PSSCH, SL}(i) = min (P_{CMAX}, P_{PSSCH, D}(i))
P_{O, SL} is the P0 value for SL pathloss based power control for PSSCH/PSCCH. If sl-
P0-PSSCH-PSCCH-r17 is configured and supported by the UE it is used for P_{O, SL},
else if sl-P0-PBSCH-r16 is configured it is used for P_{O, SL}, else SL pathloss based
power control for PSSCH/PSCCH is disabled.
sl-P0-PSSCH-PSCCH-r16 has a range of −16 . . . 15
sl-P0-PSSCH-PSCCH-r17 has a range of −202 . . . 24
μ is the sub-carrier spacing configuration as previously described.
M_{RB}^{PSSCH} (i) is the number of resource blocks for PSSCH transmission occasion i.
α_{SL} is the alpha value for SL pathloss based power control for PSSCH/PSCCH. This
is provided by higher layer parameter sl-Alpha-PSSCH-PSCCH-r16, and is 1 if that
parameter is not configured. sl-Alpha-PSSCH-PSCCH-r16 is a value from the set
{0, 0.4, 0.5, 0.6, 0.7, 0.8, 0.9, 1}.
PL_{SL} is the SL pathloss, which is given by PL_{SL} = referenceSignalPower −
higher layer filtered RSRP:
referenceSignalPower is obtained by summing the PSSCH transmit power
per RE over all antenna ports and higher layer filtered across PSSCH
transmission occasions using filter configuration provided by sl-
FilterCoefficient.
“higher layer filtered RSRP” is the SL RSRP measured by the UE receiving
the PSSCH/PSCCH transmissions and reported to the UE that transmitted
PSSCH/PSCCH. The SL RSRP is measured on PSSCH DM-RS and filtered
across PSSCH transmission occasions using filter configuration provided by
sl-FilterCoefficient.

The UE splits its power equally among antenna ports that have non-zero power.

In one example, in symbols where PSSCH and PSCCH are transmitted, a UE determines a power, P_{PSSCH2}(i), in dBm, for a PSSCH transmission occasion i of a resource pool, on an active SL BWP b of a carrier f, and in symbols where PSSCH and PSCCH are transmitted as:

$${P}_{PSSCH 2} ( i ) = 10 {log}_{10} ( \frac{{M}_{RB}^{PSSCH} ( i ) - {M}_{RB}^{PSCCH} ( i )}{{M}_{RB}^{PSSCH} ( i )} ) + {P}_{PSSCH} ( i ) .$$

In such example, M_{RB}^{PSSCH}(i) is the number of resource blocks for PSSCH transmission occasion i; M_{RB}^{PSCCH}(i) is the number of resource blocks for PSCCH transmission occasion i; and P_{PSSCH}(i) is the PSSCH power in symbols with no PSCCH.

In one example, a UE determines a power, P_{PSCCH}(i), in dBm, for a PSCCH transmission occasion i of a resource pool, on an active SL BWP b of a carrier f, as:

$${P}_{PSCCH} ( i ) = 10 {log}_{10} ( \frac{{M}_{RB}^{PSCCH} ( i )}{{M}_{RB}^{PSSCH} ( i )} ) + {P}_{PSSCH} ( i ) .$$

In such example: M_{RB}^{PSSCH}(i) is the number of resource blocks for PSSCH transmission occasion i; M_{RB}^{PSCCH}(i) is the number of resource blocks for PSCCH transmission occasion i; and P_{PSSCH}(i) is the PSSCH power in symbols with no PSCCH.

In one example, a UE has N_{sch,TX,PSFCH} scheduled PSFCH transmissions for HARQ-ACK information and conflict information. The UE is capable of transmitting a maximum of N_{max,PSFCH}. The UE determines N_{TX,PSFCH} PSFCH to transmit, each with a power P_{PSFCH,k}(i), for 1≤k≤N_{TX,PSFCH}, for a PSFCH transmission occasion i of a resource pool, on an active SL BWP b of a carrier f. A UE can be provided with higher layer parameter dl-P0-PSFCH for P0 for DL pathloss based power control for PSFCH. The UE calculates P_{PSFCH,one} in dBm: P_{PSFCH,one}=P_{O,PSFCH}+10 log₁₀(2^{μ})+α_{PSFCH}·PL.

In such example, following parameters are defined as shown in TABLE 5.

TABLE 5
Definition of parameters

P_{O, PSECH} is the P0 value for DL pathloss based power control for PSFCH. If dl-P0-PSFCH-
r17 is configured and supported by the UE it is used for P_{O, PSFCH}, else if dl-P0-PSFCH-r16
is configured it is used for P_{O, PSECH}, else DL pathloss based power control for PSFCH is
disabled, i.e., P_{PSFCH, k}(i) = P_{CMAX} − 10 log₁₀(N_{TX, PSFCH}), where P_{CMAX} is determined for
N_{TX, PSFCH} transmissions.
dl-P0-PSFCH-r16 has a range of −16 . . . 15
dl-P0-PSFCH-r17 has a range of −202 . . . 24
μ is the sub-carrier spacing configuration.
α_{PSFCH} is the alpha value for DL pathloss based power control for PSFCH. This is provided
by higher layer parameter dl-Alpha-PSFCH-r16, and is 1 if that parameter is not configured.
dl-Alpha-PSFCH-r16 is a value from the set {0, 0.4, 0.5, 0.6, 0.7, 0.8, 0.9, 1}.
PL is the pathloss, which is given by PL = PL_{b, f, c}(q_{d}) when the active SL BWP is on
serving cell c. The RS resource q_{d} for determining the pathloss is given by:
When the UE is configured to monitor PDCCH for detection of DCI Format 0_0 in
serving cell c: RS resource used for determining the power of a PUSCH transmission
scheduled by DCI Format 0_0 in serving cell c.
When the UE is not configured to monitor PDCCH for detection of DCI Format 0_0 in
serving cell c: RS resource corresponding to SS/PBCH block used by the UE to obtain the
MIB.

For LTE SL, a UE can operate with SL CA for some modes of resource allocation (modes 3 and 4). When operating in CA, a given (SL) MAC PDU is transmitted, and if necessary re-transmitted, on a single SL carrier, and multiple MAC PDUs can be transmitted in parallel on different carriers. This provides a throughput gain in a similar way as for Uu CA. It is also possible that the UE allowed to transmit and receive on multiple SL carriers (pre) configured by the network can select specific SL one or more carriers among them for transmission.

SL CA for resource allocation mode 3 using a dynamic grant is similar to the CA operation on the Uu interface that includes a carrier indication field (CIF) in the DCI from the eNB. This indicates which among the up to 8 configured SL carriers the allocation in the DCI applies to.

SL CA for resource allocation mode 4 uses a sensing procedure to select resources independently on each involved carrier. The same carrier is used for all MAC PDUs of the same SL process at least until the process triggers resource re-selection. Procedures to avoid unexpected UE behavior when the demands of CA become high allow a UE to drop a transmission which uses an excessive amount of resources or transmit chains, or to reject and re-select resources for which it cannot meet the RF requirements under CA.

For synchronization in an LTE SL CA operation, a SyncRef UE uses a single synchronization reference for all aggregated carriers, and may transmit SLSS/PSBCH on one or multiple carriers according to a capability. A receiving UE uses the same synchronization reference (not necessarily a SyncRef UE) for all its aggregated carriers, and the UE uses the highest priority synchronization reference present among the available synchronization carriers.

When a UE is configured for SL operation on multiple carriers and may transmit S-SS/PSBCH blocks on multiple carriers, the UE determines a power for each S-SS/PSBCH block transmission as described in 3GPP standard specification TS 38.213. If the UE may transmit S-SS/PSBCH blocks that may overlap in time on respective carriers and a total power for the transmissions of the S-SS/PSBCH blocks may exceed P_{CMAX}, the UE reduces a power for one or more of the S-SS/PSBCH blocks transmissions so that a resulting total power may not exceed P_{CMAX}.

When a UE may transmit PSSCHs and PSCCHs on multiple carriers, the UE determines a power for each PSSCH and PSCCH transmission as described in 3GPP standard specification TS 38.213. If the UE may transmit PSCCHs or PSSCHs that may overlap in time on respective carriers and a total power for the transmission of the PSCCHs or PSSCHs may exceed P_{CMAX}, the UE reduces a power for a transmission of a PSCCH or PSSCH that has the largest priority value as determined by SCI formats provided by the PSCCHs scheduling the respective PSSCHs. If more than one PSCCH/PSSCH transmissions have the largest priority value, the UE autonomously selects one of the more than one PSCCH/PSSCH transmissions to reduce a respective power. If, after the reduction of the power for the transmission of the PSCCH or the PSSCH with the largest priority value, a total power does not exceed P_{CMAX}, the UE transmits the PSCCHs or the PSSCHs, respectively. If, after the reduction of the power of the PSCCH or the PSSCH with the largest priority value, a total power exceeds P_{CMAX}, the UE drops the PSCCH or the PSSCH with the largest priority value, respectively, and repeats the procedure over the remaining PSCCHs or PSSCHs.

When a UE may simultaneously transmit PSFCHs and receive PSFCHs on multiple carriers, the UE performs the procedures described in 3GPP standard specification TS 38.213 by considering all the PSFCHs for transmission and all the PSFCHs for reception in order to determine either PSFCHs to transmit or PSFCHs to receive. If a UE may simultaneously transmit PSFCHs on multiple carriers, the UE performs the procedures for single carrier by considering all the PSFCHs for transmission using a corresponding P_{CMAX} in order to determine PSFCHs to transmit and a corresponding power per PSFCH transmission. The UE expects to determine a same time resource and a same power for each of the PSFCH transmissions on multiple carriers.

A transmission and reception of physical SL shared channel (PSSCH), physical SL control channel (PSCCH), and physical SL feedback channel (PSFCH) are confined within and associated with a resource pool, with parameters (pre-) configured by higher layers (e.g., SL-PSSCH-Config, SL-PSCCH-Config, and SL-PSFCH-Config, respectively).

A UE may transmit the PSSCH in consecutive symbols within a slot of the resource pool, and PSSCH resource allocation starts from the second symbol configured for SL, e.g., startSLsymbol+1, and the first symbol configured for SL is duplicated from the second configured for SL, for AGC purpose. The UE may not transmit PSSCH in symbols not configured for SL, or in symbols configured for PSFCH, or in the last symbol configured for SL, or in the symbol immediately preceding the PSFCH. The frequency domain resource allocation unit for PSSCH is the sub-channel, and the sub-channel assignment is determined using the corresponding field in the associated SCI.

For transmitting a PSCCH, the UE can be provided a number of symbols (either 2 symbols or 3 symbols) in a resource pool (e.g., sl-TimeResourcePSCCH) starting from the second symbol configured for SL, e.g., startSLsymbol+1; and further provided a number of RBs in the resource pool (e.g., sl-FreqResourcePSCCH) starting from the lowest RB of the lowest sub-channel of the associated PSSCH.

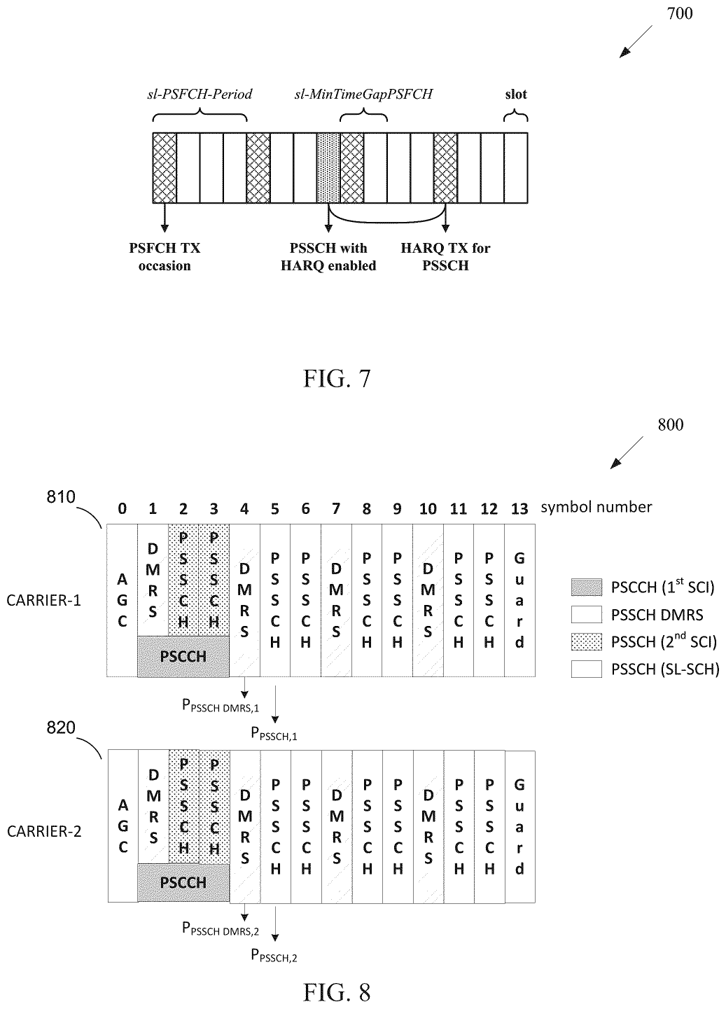

In a time domain, the UE can be further provided a number of slots (e.g., sl-PSFCH-Period) in the resource pool for a period of PSFCH transmission occasion resources, and a slot in the resource pool is determined as containing a PSFCH transmission occasion, if the relative slot index within the resource pool is an integer multiple of the period of PSFCH transmission occasion, and with at least a number of slots provided by sl-MinTimeGapPSFCH after the last slot of the PSSCH reception. PSFCH is transmitted in two contiguous symbols in a slot, wherein the second symbol is with index startSLsymbols+lengthSLsymbols−2, and the two symbols are repeated. An illustration of the time domain resource determination for PSFCH is illustrated in FIG. 7.

FIG. 7 illustrates an example of a time domain resource determination for PSFCH 700 according to embodiments of the present disclosure. An embodiment of the a time domain resource determination for PSFCH 700 shown in FIG. 7 is for illustration only.

When a UE is configured for a SL operation on multiple carriers, a procedure for resource allocation for transmissions on each carrier of the multiple carriers can jointly or independently allocate resources on some or all of the multiple carriers.

In one example, the procedure for resource allocation on each carrier of the multiple carriers ensures that resources for PSCCHs, PSSCHs, and PSFCHs are aligned in time over the multiple carriers, and an overlap in a time of transmissions on different carriers may involve transmissions of a same channel. For example, in some or all of the multiple carriers, the overlap in time may happen between transmissions of PSCCHs only, or of PSSCHs only, or of PSFCHs only.

In one example, the procedure for resource allocation on each carrier of the multiple carriers does not ensure that resources for PSCCHs, PSSCHs, and PSFCHs are aligned in time over the multiple carriers, and an overlap in a time of transmissions on different carriers may involve transmissions of more than one channel. For example, in some or all of the multiple carriers, the overlap in a time may happen between transmissions of PSCCHs, PSSCHs and PSFCHs.

When a UE is configured for a SL operation on multiple carriers, whether the procedure for resource allocation for transmission on each carrier of the multiple carriers has restrictions to ensure that resources for transmissions for a same channel are aligned in a time over the multiple carriers (or equivalently, joint SL resource allocation in a time domain over the multiple carriers) or not (or equivalently, separate SL resource allocation in a time domain for the multiple carriers), can be subject to a configuration.

If the UE is configured with joint SL resource allocation in a time domain over the multiple carriers and an overlap in a time among transmissions of PSCCHs, PSSCHs, or PSFCHs, may occur, the UE may transmit the PSCCHs, the PSSCHs, or the PSFCHs, according to the procedures described above.

If the UE is configured with separate SL resource allocation without aligned time resources over the multiple carriers, an overlap in a time between transmissions of different channels may occur. Thus, the UE needs to determine a power for transmission of each of the overlapping channels on the respective multiple carriers.

The present disclosure relates to SL transmissions for an operation on multiple carriers. The present disclosure relates to determining powers for the multiple SL transmissions over the multiple carriers when PSCCH/PSSCH transmissions overlap in time over at least two carriers. The disclosure also relates to determining powers for the multiple SL transmissions over the multiple carriers when PSCCH/PSSCH and PSFCH transmissions overlap in time over at least two carriers.

In SL, “reference RS” can correspond to a set of characteristics for SL beam, such as a direction, a precoding/beamforming, a number of ports, and so on. This can correspond to a SL receive beam or to a SL transmit beam. At least two UEs are involved in a SL communication. It is referred that a first UE is identified as a UE-A and to second UE as UE-B. In one example, the UE-A is transmitting SL data on PSSCH/PSCCH, and UE-B is receiving the SL data on PSSCH/PSCCH.

In the present disclosure, an RRC signaling (e.g., configuration by RRC signaling) includes the following: (1) an RRC signaling over the Uu interface, this can be system information block (SIB)-based RRC signaling (e.g., SIB1 or other SIB) or an RRC dedicated signaling that is sent to a specific UE, and/or (2) PC5-RRC signaling over the PC5 or SL interface.

In the present disclosure, a MAC CE signaling includes: (1) a MAC CE signaling over the Uu interface, and/or (2) MAC CE signaling over the PC5 or SL interface.

In the present disclosure, an L1 control signaling includes: (1) an L1 control signaling over the Uu interface, this can include (1a) DL control information (e.g., DCI on PDCCH) and/or (1b) UL control information (e.g., UCI on PUCCH or PUSCH), and/or (2) SL control information over the PC5 or SL interface, this can include (2a) first stage SL control information (e.g., first stage SCI on PSCCH), and/or (2b) second stage SL control information (e.g., second stage SCI on PSSCH) and/or (2c) feedback control information (e.g., control information carried on PSFCH).

In the present disclosure, a carrier from the multiple carriers for SL CA can be identified for a communication between a first UE and a second UE. In one example, for the first UE, a same carrier is used to transmit PSSCH/PSCCH and PSFCH from the first UE to the second UE. In one example, for the first UE, a same carrier is used to receive PSSCH/PSCCH and PSFCH at the first UE from the second UE.

In one example, for the first UE, different carriers are used to transmit PSSCH/PSCCH and PSFCH from the first UE to the second UE. In one example, for the first UE, different carriers are used to receive PSSCH/PSCCH and PSFCH at the first UE from the second UE. In one example, for the first UE, different carriers are used to transmit PSSCH and PSCCH from the first UE to the second UE. In one example, for the first UE, different carriers are used to receive PSSCH and PSCCH at the first UE from the second UE. The roles of the first and second UEs can be interchanged.

In the present disclosure, without a loss of any generality, a UE-A is the SL UE transmitting PSSCH/PSCCH or receiving PSFCH and a UE-B is the SL UE receiving PSSCH/PSCCH or transmitting PSFCH. A communication has been established between the UE-A and the UE-B (e.g., for PSSCH/PSCCH or PSFCH) and a carrier or a carrier pair has been determined, e.g., the UE-A transmits PSSCH/PSCCH on a first carrier and the UE-B receives PSSCH/PSCCH on the first carrier or a second carrier.

In the present disclosure, descriptions and examples for a SL operation on two carriers equally apply to a SL operation on more than two carriers, or to a set of carriers from the multiple carriers when the UE is configured for a SL operation on multiple carriers that include one or more sets of carriers from the multiple carriers, and each set of carriers can include two or more carriers.

FIG. 8 illustrates an example of UE configured for a SL operation on two carriers 800 according to embodiments of the present disclosure. An embodiment of the UE configured for a SL operation on two carriers 800 shown in FIG. 8 is for illustration only.

FIG. 8 illustrates an example for a UE configured for SL operation on two carriers, and PSCCHs or PSSCHs overlap in a time on respective carriers. Resources for transmissions of PSSCHs or PSCCHs are aligned in time, and on each symbol the UE transmits the same channel on both carriers.

When a UE is configured for a SL operation on multiple carriers, the UE can transmit on the multiple carriers using the same slot format. For example, the UE is configured for a SL operation on a first carrier and a second carrier, and in a slot n, PSCCH is transmitted in three SL symbols and is multiplexed in the frequency domain with PSSCH as illustrated in 810 of FIG. 8.

It is possible that in the symbols where PSCCH is transmitted, the PSCCH is not multiplexed with PSSCH and occupies the entire range of frequency resources. The automatic gain control (AGC) symbol is a duplication of symbol 1 and is used to adjust the power of the received signal in order to reduce the quantization error or the clipping of the signal at the analog to digital converter (ADC) since the received signal power can vary over a wide dynamic range depending on the channel attenuation and interference. The PSSCH DM-RS can be transmitted in two, three, or four SL symbols in different locations within a slot depending on the number of symbols for PSCCH, the number of symbols with PSSCH DM-RS and the number of symbols for PSSCH within a slot.

When transmissions of PSCCH(s)/PSSCH(s) or PSSCH(s) overlap in a time, the UE determines a power for the transmission of the PSCCH(s) or PSSCH(s) in the two carriers, and if a total power for the transmission of the PSCCHs or PSSCHs may exceed P_{CMAX}, the UE reduces a power for a transmission of a PSCCH or PSSCH according to the procedure previously described.

In one example, the UE determines the powers P_{PSSCH,1} and P_{PSSCH,2} for the overlapping PSSCH transmissions on the respective two carriers and uses the same powers for all PSSCH symbols of the slot, for example, for symbols {5, 6, 8, 9, 11, 12}, or for symbols 5 to 12, or for subsequent PSSCH symbols within a time interval. PSSCH symbols of the slot that are transmitted with a same power over a carrier can be symbols of a same TB that is scheduled by a SCI and/or configured by higher layers, or can be symbols of different TBs transmitted in the same slot, wherein the different TBs are scheduled by a same SCI or by different corresponding SCI.

In one example, the UE determines powers P_{PSSCH,1} and P_{PSSCH,2} for the overlapping PSSCH transmissions in a PSCCH-PSSCH transmission occasion (i) on respective first and second carriers based on parameters described in 3GPP TS 38.213 v17.6.0, “NR; Physical Layer Procedures for Control.”, Clauses 16.2.1, and associated with the PSCCH-PSSCH transmission occasion (i). The UE uses the determined powers for transmission of the PSSCH symbols in the PSCCH-PSSCH transmission occasion (i), and/or for transmission of the PSSCH symbols in PSCCH-PSSCH transmission occasions subsequent to transmission occasion (i) within a slot, wherein the slot includes the PSCCH-PSSCH transmission occasion (i) and some or all of the subsequent PSCCH-PSSCH transmission occasions, and/or for transmission of the PSSCH symbols in PSCCH-PSSCH transmission occasions subsequent to transmission occasion (i) within a pre-defined or configured time interval that may or may not include the PSCCH-PSSCH transmission occasion (i).

In one example, the UE determines powers P_{PSSCH,1} and P_{PSSCH,2} for the overlapping PSSCH transmissions on respective first and second carriers and uses the determined powers for transmission of the PSSCH symbols of the overlapping PSSCH transmissions, wherein the PSSCH symbols on the first carrier are symbols of a same TB that is scheduled by a first SCI and/or configured by higher layers, and the PSSCH symbols on the second carrier are symbols of a same TB that is scheduled by a second SCI and/or configured by higher layers.

In one example, the UE determines powers P_{PSSCH,1} and P_{PSSCH,2} for the overlapping PSSCH transmissions on respective first and second carriers and uses the determined powers for transmission of the PSSCH symbols of the overlapping PSSCH transmissions, wherein the PSSCH symbols on the first carrier are symbols of a same TB that is scheduled by a first SCI and the first SCI schedules multiple TBs on the first carrier, and the PSSCH symbols on the second carrier are symbols of a same TB that is scheduled by a second SCI and the second SCI schedules multiple TBs on the second carrier.

In one example, the UE determines powers P_{PSSCH,1} and P_{PSSCH,2} for the overlapping PSSCH transmissions on respective first and second carriers and uses the determined powers for transmission of the PSSCH symbols of the overlapping PSSCH transmissions, wherein the PSSCH symbols on the first carrier are symbols of a first TB and the PSSCH symbols on the second carrier are symbols of a second TB, first and second TBs are scheduled by an SCI, and the SCI is transmitted on the first carrier or on the second carrier. The carrier used for the transmission of the SCI can be referred as an anchor carrier.

In one example, the UE transmits PSSCH symbols of a TB over multiple slots using a same power on a first carrier, and the power is determined in the first slot based on the overlapping of PSSCH symbols on the first carrier with PSSCH symbols on a second carrier as illustrated in 820 of FIG. 8.

It is possible that the UE transmits PSSCH symbols of the TB transmitted over multiple slots with different powers on different slots, and in each slot of the multiple slots the UE determines the transmit power based on the overlapping of PSSCH symbols on the first carrier with PSSCH symbol on the second carrier, if any.

In one example, the UE uses a first power for the transmission of PSSCH symbols and PSSCH DM-RS symbols in the same slot on a first carrier and uses a second power for the transmission of PSSCH symbols and PSSCH DM-RS symbols in the same slot on a second carrier. For example, the UE determines the powers for transmission of symbol 4 in the first and second carriers and transmits symbols 4 to 12 with the same respective powers on the respective carriers. For example, the UE determines the powers P_{PSSCH,1} and P_{PSSCH,2} for the overlapping PSSCH transmissions on the respective two carriers and uses the same respective powers for PSSCH DM-RS transmissions on the respective carriers.

In one example, the UE determines the powers on the two carriers for each of the symbols of the slots and PSSCH symbols in different locations in the same slot can be transmitted with different powers.

In one example, the UE determines the powers for PSSCH transmissions on the two carriers for a group of symbols, wherein symbols of the group of symbols are within a slot or over multiple slots or associated to a transmission occasion, and uses the determined powers for transmission of the symbols on the two carriers.

In one example, the UE determines the powers for PSSCH transmissions on the two carriers for a first group of symbols, wherein symbols of the first group of symbols are within a slot or over multiple slots, and uses the determined powers for transmission of symbols of a second group of symbols within the slot or over multiple slots on the two carriers.

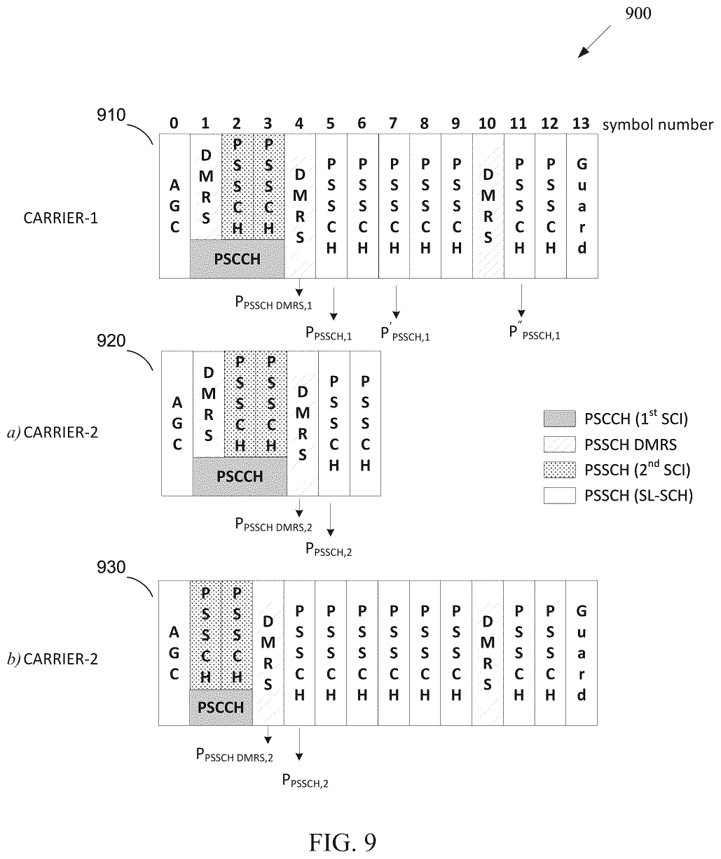

FIG. 9 illustrates another example of UE configured for a SL operation on two carriers 900 according to embodiments of the present disclosure. An embodiment of the UE configured for a SL operation on two carriers 900 shown in FIG. 9 is for illustration only.

FIG. 9 illustrates examples for a UE configured for SL operation on two carriers when a) a first PSCCH or PSSCH on a first carrier overlaps in time with a second PSSCH or PSCCH on a second carrier in some of the symbols of a slot, or b) a first channel on the first carrier overlaps in time with a second channel on the second carrier, and first and second channels are different channels.

As in example a) of FIG. 9, when a UE is configured for SL operation on multiple carriers, the UE can be scheduled to transmit a first number of PSSCH symbols on a first carrier and a second number of PSSCH symbols on a second carrier, and a first set of symbols from the first number of PSSCH symbols on the first carrier overlaps with the second number of PSSCH symbols on the second carrier and a second set of symbols from the first number of PSSCH symbols on the first carrier does not overlap with transmissions on the second carrier.

In one example, the UE determines a first power P_{PSSCH,1} for the transmission of the PSSCH in the first set of symbols from the first number of symbols on the first carrier and a second power P_{PSSCH,2} for the transmission of the PSSCH in the second number of symbols on the second carrier based on a procedure for determining a power for transmission of PSSCHs that overlap in time, and uses the first power and the second power for transmission of the PSSCH symbols on corresponding first and second carriers. Thus, all symbols of the PSSCH transmission on the first carrier, wherein some symbols overlap with PSSCH symbols on the second carrier and some other symbols do not overlap with PSSCH symbols on the second carrier, are transmitted with the same power.

The procedure for determining a power for transmission of PSSCHs that overlap in a time is performed as follows. UE determines a power for each transmission of PSSCHs on respective carriers as described in 3GPP standard specification TS 38.213, and if a total power for the transmission of the PSSCHs may exceed P_{CMAX}, the UE reduces the power for the transmission of PSSCH on one of the carriers based on the largest priority value as determined by SCI formats provided by the PSCCHs scheduling the respective PSSCHs.

If both PSSCHs transmissions have the largest priority value, the UE selects one of the PSSCH transmission to reduce a respective power based on a first rule and/or a first configuration, wherein the first rule can be to reduce the power of the PSSCH with a smaller number of overlapping symbols, or the PSSCH on a carrier with a larger number of PSCCH DM-RS symbols, or the PSSCH on a carrier with the smaller path loss estimate, or the PSSCH on a carrier that is associated with a largest priority value indicated by a higher layer parameter that can be part of the carrier configuration.

If, after the reduction of the power for one of the PSSCH transmission, a total power does not exceed P_{CMAX}, the UE transmits the PSCCHs. If, after the reduction of the power for one of the PSSCH transmission, a total power exceeds P_{CMAX}, the UE drops one of the PSSCHs based on a second rule and/or on a second configuration, wherein the second rule can be based on dropping the PSSCH with power reduction that corresponds to the PSSCH with the largest priority value, and the second configuration can indicate priority values associated with the configured carriers. The above descriptions equally apply when the smallest priority value is considered.

In one example, the UE determines a first power for the transmission of the PSSCH on the first carrier and a second power for the transmission of the PSSCH on the second carrier based on the overlap of the PSSCH transmissions, and uses the first power and second power for a transmission of the PSSCH symbols that overlap on the first and second carriers, wherein first and second powers are determined according to the procedure for determining a power for transmission of PSSCHs that overlap in time. The remaining symbols of the PSSCH transmission on the first carrier that do not overlap with the PSSCH transmission on the second carrier are transmitted with a third power that is determined for the PSSCH transmission on that carrier as described in 3GPP standard specification TS 38.213. Thus, the UE determines a new power for transmission of PSSCH symbols that do not overlap with symbols on the second carrier.

In one example, the UE determines a first power for the transmission of the PSSCH on the first carrier and a second power for the transmission of the PSSCH on the second carrier based on the overlap of the PSSCH transmissions and uses the first power for transmission of consecutive PSSCH symbols. After a transmission gap of at least one symbol, the UE determines a new power for transmission of the PSSCH symbols after the transmission gap.

For a first PSSCH transmission on a first carrier that partially overlaps with a second PSSCH transmission on a second carrier, whether a UE transmits all symbols of the first PSSCH transmission on the first carrier with a same power or transmits overlapping and non-overlapping symbols with different powers can be subject to a configuration and/or to a UE capability.

As illustrated in FIG. 9, a PSSCH transmission on a first carrier 910 partially overlaps with a second PSSCH transmission on a second carrier 920. The PSSCH transmission on the first carrier includes symbols {5, 6, 7, 8, 9, 11, 12}, and the PSSCH transmission on the second carrier includes symbols {5, 6}. The UE determines the powers P_{PSSCH,1} and P_{PSSCH,2} for transmission of the PSSCHs on the first and second carriers based on the procedure for determining a power for transmission of PSSCHs that overlap in time.

In one example, the UE transmits symbols {5, 6, 7, 8, 9, 11, 12} on the first carrier with power P_{PSSCH,1} and transmits symbols {5, 6} on the second carrier with power P_{PSSCH,2}, wherein the PSSCH transmission scheduled by an SCI format comprises symbols {5, 6, 7, 8, 9, 11, 12}.

In one example, the UE transmits symbols {5, 6} on the first carrier with power P_{PSSCH,1} and transmits symbols {5, 6} on the second carrier with power P_{PSSCH,2}. Symbols {7, 8, 9, 11, 12} are transmitted with power P′_{PSSCH,1} determined as described in 3GPP standard specification TS 38.213.

In one example, the UE transmits symbols {5, 6, 7, 8, 9} on the first carrier with power P_{PSSCH,1} and transmits symbols {5, 6} on the second carrier with power P_{PSSCH,2}. Symbols {11, 12}, after a DM-RS symbol 10, are transmitted with power P″_{PSSCH,1} determined as described in 3GPP standard specification TS 38.213.

When a UE is configured for operation on multiple carriers and there is partial overlap between PSSCH transmissions on multiple carriers, the UE determines the powers for transmission on respective carriers based on the overlap of the PSSCH transmissions and uses the determined powers for transmission of all symbols of each PSSCH transmission on respective carriers. The determination of the powers is done considering all carriers for which an overlap exists at least in one symbol of each PSSCH transmission on respective carriers.

When a UE is configured for operation on multiple carriers and there is partial overlap between PSSCH transmissions on multiple carriers, the UE determines the powers for transmission of a symbol on respective carriers based on the overlap of the PSSCH transmissions on the symbol and uses the determined powers for transmission of the symbols of each PSSCH transmission on respective carriers.

As in example b) of FIG. 9, when a UE is configured for SL operation on multiple carriers, the UE can be scheduled a first PSCCH/PSSCH or PSSCH transmission on a first number of symbols on a first carrier 910 and a second PSCCH/PSSCH or PSSCH transmission on a second number of symbols on a second carrier 930, and transmission of PSCCH/PSSCH on the first carrier and PSSCH on the second carrier overlap in time in symbol i=3. On the first carrier, the UE determines a power P_{PSCCH,1}(i) for a PSCCH transmission on a resource pool in PSCCH-PSSCH transmission occasion i and a power P_{PSSCH,1} (i) for a PSSCH transmission. On the second carrier, the UE determines a PSSCH power P_{PSSCH,2}(i) for a PSSCH transmission on a resource pool in symbols where a corresponding PSCCH is not transmitted in PSCCH-PSSCH transmission occasion i.

If a total power for the transmission of the PSCCH/PSSCH on the first carrier and PSSCH on the second carrier may exceed P_{CMAX}, in one example, the UE reduces a power for a transmission of the PSSCH that is not transmitted in a PSCCH-PSSCH transmission occasion (e.g., the PSSCH on the second carrier 930). If after power reduction, the total power may still exceed P_{CMAX}, the UE drops the PSSCH that is not transmitted in the PSCCH-PSSCH transmission occasion.

If a total power for the transmission of the PSCCH/PSSCH on the first carrier and PSSCH on the second carrier may exceed P_{CMAX}, in one example, the UE reduces a power for a transmission of the PSSCH that is not transmitted in a PSCCH-PSSCH transmission occasion (e.g., the PSSCH on the second carrier 930) and of the PSSCH transmitted in PSCCH-PSSCH transmission occasion i of a same or a different amount. If after power reduction, the total power may still exceed P_{CMAX}, the UE drops the PSSCH that is not transmitted in a PSCCH-PSSCH transmission occasion.

If a total power for the transmission of the PSCCH/PSSCH on the first carrier and PSSCH on the second carrier may exceed P_{CMAX}, in one example, the UE drops the PSSCH that is not transmitted in a PSCCH-PSSCH transmission occasion.

If a total power for the transmission of the PSCCH/PSSCH on the first carrier and PSSCH on the second carrier would exceed P_{CMAX}, in one example, whether the UE reduces the power on a carrier depends on whether the PSSCH carries DM-RS.

When a UE is configured with a SL operation on multiple carriers, and is also configured priority values associated with the multiple carriers, if a total power for the transmission of PSCCH/PSSCH in a PSCCH-PSSCH transmission occasion on a first carrier and PSSCH in a PSSCH transmission occasion on a second carrier may exceed P_{CMAX}, the UE drops the transmission on the carrier with the largest priority value. For multiple carriers, if the total power may still exceed P_{CMAX} after dropping the transmission on the carrier with the largest priority, the UE repeats the procedure for the remaining transmissions. It is also possible that a priority associated with a carrier is used only for selecting a transmission among the PSSCH transmissions in PSSCH transmission occasions over the multiple carriers.

For example, for multiple carriers, if the PSCCH/PSSCH transmission on a first carrier overlaps with a number of PSSCH transmissions on a number of carriers, and the total power may exceed P_{CMAX}, the UE drops the PSSCH transmission on the carrier with the largest priority value, and if the total power may still exceed P_{CMAX} after dropping the PSSCH transmission, the UE repeats the procedure for the remaining transmissions.

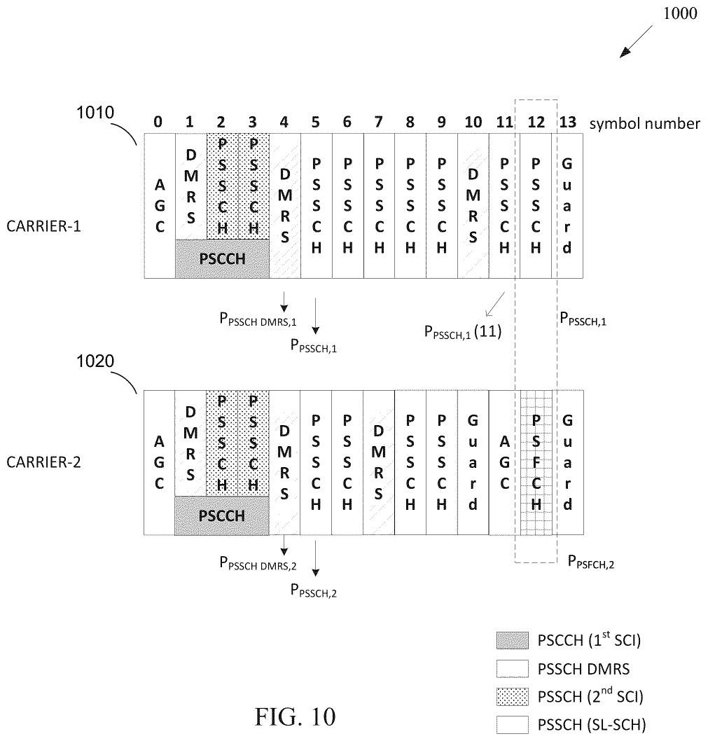

FIG. 10 illustrates yet another example of UE configured for a SL operation on two carriers 1000 according to embodiments of the present disclosure. An embodiment of the UE configured for a SL operation on two carriers 1000 shown in FIG. 10 is for illustration only.

FIG. 10 illustrates an example for a UE configured for SL operation on two carriers, and a slot on a first carrier does not include PSFCH and on a second carrier includes a PSFCH symbol. A PSSCH on the first carrier overlaps with a PSFCH on the second carrier in symbol i=12. The UE determines a transmission power for the scheduled PSFCH transmission for HARQ-ACK information or conflict information and a transmission power for the PSSCH. If a total power for the transmission of the PSFCH on the second carrier and the PSSCH on the first carrier may exceed P_{CMAX}, in a first example the UE drops the PSSCH transmission and transmits the PSFCH with the determined power. In a second example, the UE reduces the power of the PSSCH transmission so that the total power may not exceed P_{CMAX}, and transmits both PSSCH on the first carrier and PSFCH on the second carrier. Whether the UE behaviour is according to the first example or the second example can be subject to a configuration. For example, if the PSSCH is scheduled for transmission on a carrier with the smallest priority value, the UE acts according to the second example, otherwise the UE acts according to the first example, or vice versa.

When a UE may simultaneously transmit PSFCHs on multiple carriers, the UE performs the procedures for single carrier in 3GPP standard specification TS 38.213 while considering all the PSFCHs for transmission using a corresponding P_{CMAX} in order to determine PSFCHs to transmit and a corresponding power per PSFCH transmission. The UE expects to determine a same time resource and a same power for each of the PSFCH transmissions on multiple carriers. When in the same time resource on a different carrier the UE may transmit a PSSCH, and a total power for the transmission of the PSSCH and the PSFCHs may exceed P_{CMAX}, the UE drops the PSSCH transmission or reduces its power so that the total power does not exceed P_{CMAX}, and transmits the PSFCHs using the determined power for each of the PSFCH transmissions.

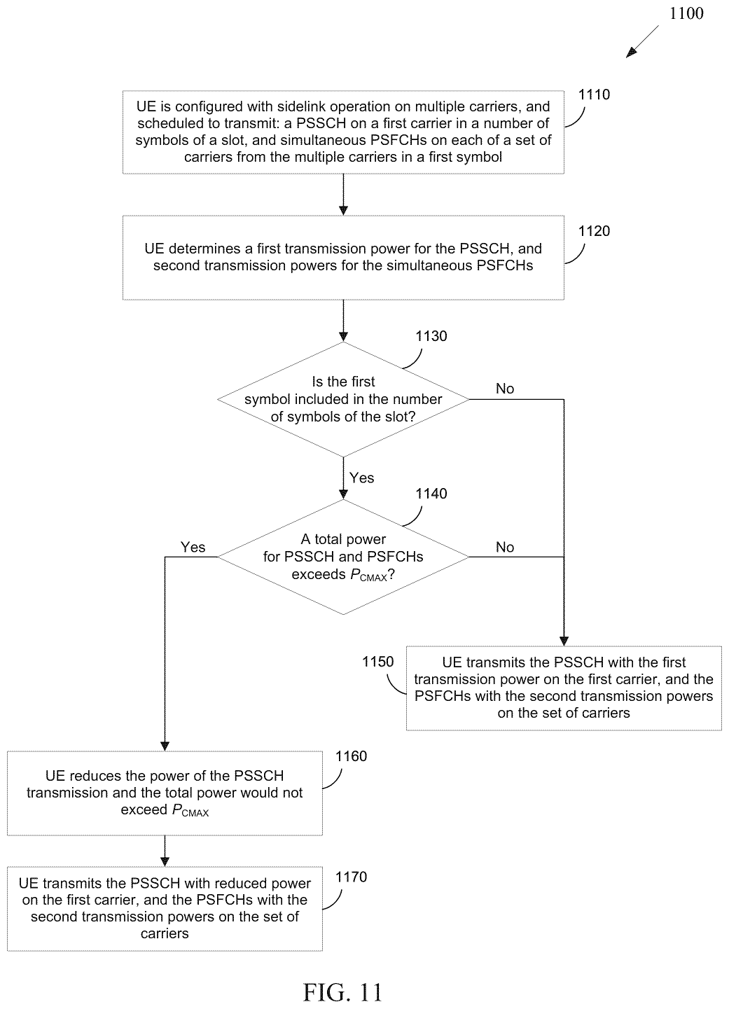

FIG. 11 illustrates a flowchart of a UE method 1100 for determining a power for a transmission of a PSSCH and PSFCHs that overlap in a time domain according to embodiments of the present disclosure. The UE method 1100 as may be performed by a UE (e.g., 111-116 as illustrated in FIG. 1). An embodiment of the UE method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

A UE is configured with SL operation on multiple carriers and scheduled to transmit: a PSSCH on a first carrier in a number of symbols of a slot, and simultaneous PSFCHs on each of a set of carriers from the multiple carriers in a first symbol 1110. The UE determines a first transmission power for the PSSCH, and second transmission powers for the simultaneous PSFCHs 1120. When the first symbol is not included in the number of symbols of the slot 1130, the UE transmits the PSSCH with the first transmission power on the first carrier, and the PSFCHs with the second transmission powers on the set of carriers 1150. Otherwise, when a total power for PSSCH and PSFCHs does not exceed P_{CMAX} 1140, the UE transmits the PSSCH with the first transmission power on the first carrier, and the PSFCHs with the second transmission powers on the set of carriers 1150. Otherwise, the UE reduces the power of the PSSCH transmission, and the total power may not exceed P_{CMAX} 1160. The UE transmits the PSSCH with reduced power on the first carrier, and the PSFCHs with the second transmission powers on the set of carriers 1170.

For a UE transmitting PSFCH, a power P_{PSFCH} for a PSFCH transmission can be based on the pathloss between the gNB and the UE (i.e., the DL pathloss), or on the SL pathloss in order to avoid transmitting at a power larger than necessary, or on a combination of DL pathloss and SL pathloss. The PSFCH power control parameters associated with the DL pathloss such as: P_{O,PSFCH} which is a value of dl-P0-PSFCH, α_{PSFCH} which is a value of dl-Alpha-PSFCH, are configured separately from the corresponding parameters dl-P0-PSSCH-PSCCH and dl-Alpha-PSSCH-PSCCH for the PSCCH/PSSCH power control, and can be configured per carrier f or per set of carriers or per carrier combination or per portions of a BWP or with a same value for all configured carriers. The PSFCH power control parameters associated with the SL pathloss such as: P_{O,PSFCH} which is a value of sl-P0-PSFCH, α_{PSFCH} which is a value of sl-Alpha-PSFCH are configured separately from the corresponding parameters sl-P0-PSSCH-PSCCH and sl-Alpha-PSSCH-PSCCH for the PSCCH/PSSCH power control, and can be configured per carrier f or per set of carriers or per carrier combination or per portions of a BWP or with a same value for all configured carriers.

It is possible that the above power control parameters are configured per beam. For example, the power control parameter dl-P0-PSSCH-PSCCH, or dl-Alpha-PSSCH-PSCCH, is configured with multiple values for a carrier, and the multiple values correspond to multiple beams used for transmission, or for transmission and reception of PSCCH/PSSCH by the UE. Similarly, power control parameters for PSFCH can be configured per beam. It is also possible that power control parameters associated with SL pathloss, for transmission of PSFCH or PSSCH/PSSCH can be configured per beam.

When a UE is configured with a SL operation on a single carrier f, the UE with N_{sch,Tx,PSFCH} scheduled PSFCH transmissions for HARQ-ACK information and conflict information, and capable of transmitting a maximum of N_{max,PSFCH} PSFCHs, determines a number N_{Tx,PSFCH} of simultaneous PSFCH transmissions and a power P_{PSFCH,k}(i) for a PSFCH transmission k, 1≤k≤N_{Tx,PSFCH}, on all the resource pools in PSFCH transmission occasion i on active SL BWP b of carrier f based on a P_{CMAX} determined for N_{sch,Tx,PSFCH} PSFCH transmissions from the descriptions in 3GPP standard specification TS 38.101-1, and according to the procedure described in 3GPP standard specification TS 38.213.

When a UE is configured with a SL operation on multiple carriers, and there is an overlap of PSFCH transmissions on N carriers, the UE with N_{sch,Tx,PSFCH} scheduled PSFCH transmissions for HARQ-ACK information and conflict information, and capable of transmitting a maximum of N_{max,PSFCH} PSFCHs over the N carriers, determines a number N_{Tx,PSFCH} of simultaneous PSFCH transmissions and a power P_{PSFCH,k}(i) for a PSFCH transmission k, 1≤k≤N_{Tx,PSFCH}, on all the resource pools in PSFCH transmission occasion i on active SL BWP b of each carrier f of the N carriers based on a P_{CMAX} determined for N_{sch,Tx,PSFCH} PSFCH transmissions from the descriptions in 3GPP standard specification TS 38.101-1, and according to the procedure described in 3GPP standard specification TS 38.213.

In one example, the UE determines the number N_{Tx,PSFCH} of simultaneous PSFCH transmissions and a power P_{PSFCH,k}(i) for a PSFCH transmission k, 1≤k≤N_{Tx,PSFCH}, over the N carriers, and based on the P_{CMAX} determined for N_{sch,Tx,PSFCH} PSFCH transmissions from 3GPP standard specification TS 38.101-1, wherein N_{sch,Tx,PSFCH} is the number of PSFCHs scheduled over the N carriers.

In one example, the UE determines the number N_{Tx,PSFCH,c} of simultaneous PSFCH transmissions per carrier and a power P_{PSFCH,k}(i) for a PSFCH transmission k, 1≤k≤N_{Tx,PSFCH,c} over each carrier, based on the P_{CMAX,f} which is derived from the P_{CMAX} determined for N_{sch,Tx,PSFCH} PSFCH transmissions from 3GPP standard specification TS 38.101-1, wherein N_{sch,Tx,PSFCH} is the number of PSFCHs scheduled over the N carriers.

In one example, for each carrier, the P_{CMAX,f} can be derived from the P_{CMAX} determined for N_{sch,Tx,PSFCH} PSFCH transmissions scheduled over the N carriers from 3GPP standard specification TS 38.101-1, and the value of P_{CMAX,f} is the same for each carrier.

In one example, for each carrier, the P_{CMAX,f} can be derived from the P_{CMAX} determined for N_{sch,Tx,PSFCH} PSFCH transmissions from 3GPP standard specification TS 38.101-1, considering the number N_{Tx,PSFCH,f} of simultaneous PSFCH transmissions per carrier. The derived values of P_{CMAX,f} per carrier can be same or different depending on whether the number of N_{Tx,PSFCH,c} of simultaneous PSFCH transmissions per carrier is same or different.

In one example, for each carrier, the P_{CMAX,f} can be determined for N_{sch,Tx,PSFCH,c} PSFCH transmissions from 3GPP standard specification TS 38.101-1, wherein P_{CMAX,f} is provided per each carrier.

When a UE is configured with SL operation on multiple carriers, and there is an overlap of PSFCH transmissions on a first set of N₁ carriers from the multiple carriers and of PSCCH/PSSCH transmissions on a second set of N₂ carriers from the multiple carriers, the UE with N_{sch,Tx,PSFCH} scheduled PSFCH transmissions for HARQ-ACK information and conflict information over the first set of N₁ carriers, and capable of transmitting a maximum of N_{max,PSFCH} PSFCHs over multiple carriers, determines a number N_{Tx,PSFCH} of simultaneous PSFCH transmissions and a power P_{PSFCH,k}(i) for a PSFCH transmission k, 1≤k≤N_{Tx,PSFCH}, on all the resource pools in PSFCH transmission occasion i on active SL BWP b of carrier f based on a P_{CMAX} determined for N_{sch,Tx,PSFCH} PSFCH transmissions from the descriptions in 3GPP standard specification TS 38.101-1, and according to the procedure described in 3GPP standard specification TS 38.213.

The UE determines a power for the PSCCH/PSSCH transmissions on a second set of N₂ carriers based on a P_{CMAX,PSCCH/PSSCH} according to the procedure described in 3GPP standard specification TS 38.213.

The value P_{CMAX,PSCCH/PSSCH} can be determined as the difference between a maximum power value for all transmissions over the multiple carriers configured for SL operation and a power value for the PSFCH transmissions over the multiple carriers.

The value P_{CMAX,PSCCH/PSSCH} can be the remaining power value after transmission of the PSFCHs over the first set of N₁ carriers, wherein a power P_{PSFCH,K}(i) for a PSFCH transmission k, 1≤k≤N_{Tx,PSFCH}, on all the resource pools in PSFCH transmission occasion i on active SL BWP b of each carrier f based on a P_{CMAX} determined for N_{sch,Tx,PSFCH} PSFCH transmissions from the descriptions in 3GPP standard specification TS 38.101-1, and according to the procedure described in 3GPP standard specification TS 38.213.

The value P_{CMAX,PSCCH/PSSCH} can be separately provided. For example, the UE is configured with a first P_{CMAX,PSFCH} for the PSFCH transmissions over the first set of N₁ carriers and a second P_{CMAX,PSCCH/PSSCH} for the PSCCH/PSSCH transmissions over the second set of N₂ carriers.

The values P_{CMAX, PSFCH} and P_{CMAX, PSCCH/PSSCH} can be pre-defined values provided by higher layer parameters, and additionally the UE can be indicated by a MAC CE the values to use. The values P_{CMAX, PSFCH} and P_{CMAX, PSCCH/PSSCH} can be separately configured and the indication by MAC CE can be separate for P_{CMAX, PSFCH} and P_{CMAX, PSCCH/PSSCH}. When the indication of a new value for P_{CMAX, PSFCH} and/or P_{CMAX, PSCCH/PSSCH} is received, the UE starts using the new value from a determined slot.

In one example, the UE starts using the new value from the next slot that includes a PSFCH transmission after reception of the MAC CE. In one example, the UE starts using the new value from a next period (e.g., sl-PSFCH-Period) that includes a number of slots in the resource pool for a period of PSFCH transmission occasion resources, after reception of the MAC CE. In one example, the UE starts using the new value from the slot where an overlap occurs after reception of the MAC CE.

A UE can be configured with one or more values for P_{CMAX, PSFCH} for different operations. For example, the UE can be configured with one or more values for P_{CMAX, PSFCH} for operation with single carrier, and/or can be configured with one or more values for P_{CMAX, PSFCH} for operation with multiple carriers, and/or can be configured with one or more values for P_{CMAX, PSFCH} for operation with multiple carriers and PSFCH transmissions overlap with PSCCH/PSSCH transmission. Different P_{CMAX, PSFCH} values in a configuration can be associated with different numbers of carriers or sets of carriers over which the PSFCHs, or other physical channels such as PSCCH/PSSCH are scheduled. The UE can be indicated by a MAC CE to start or stop using a configuration or to switch the configuration.

When the indication is to start, or to stop, or to switch a configuration for P_{CMAX, PSFCH} and/or P_{CMAX, PSCCH/PSSCH}, the UE starts, or stops, or switches from a determined slot. In one example, a MAC CE carrying a signaling indication to start, or stop, or switch can be placed in a MAC PDU and indicated through a MAC subheader or indicated through a MAC sub-PDU. The MAC CE may be a bit string that is byte aligned in length. Different types of MAC CEs may be used for activation, de-activation, or switching of the configuration associated with P_{CMAX, PSFCH} and/or P_{CMAX, PSCCH/PSSCH}. For example, a first MAC CE is used to activate, and a second MAC CE is used to de-activate, such as enable or stop operating with a configuration. In another example, a single MAC CE indicates one or a combination of the following, start, or stop, or change of a configuration.

In one example the UE is provided a first P_{CMAX} for transmissions over a first set of carriers and a second P_{CMAX} for transmissions over a second set of carriers, wherein, subject to a UE capability, the first P_{CMAX} is associated with the UE power corresponding to the higher power class among the UE power classes corresponding to the carriers of the first set of carriers, and the second P_{CMAX} is associated with the aggregated UE power over the second set of carriers. The UE would use the first P_{CMAX} to determine the power of simultaneous PSFCH or PSCCH/PSSCH transmissions over the first set of carriers and use the second P_{CMAX} to determine the power of simultaneous PSFCH or PSCCH/PSSCH transmissions over the second set of carriers. The UE can, additionally or alternatively, be provided a third P_{CMAX} applicable to simultaneous transmissions over carriers of the first set of carriers and the second set of carriers.

In one example the UE determines a power of each of the PSFCHs or PSCCHs/PSSCHs that the UE would simultaneously transmit on the first carriers using the first P_{CMAX}, and if the total power for the PSFCHs and PSCCHs/PSSCHs transmissions would exceed the first P_{CMAX} the UE reduces the power for the PSCCH/PSSCH transmissions only, or reduces the powers of the PSCCH/PSSCH and PSFCH transmissions, based on a configuration by higher layers or an indication in a DCI format related to a physical channel priority or to a quality of the wireless channel determined by a measured RSRP being above or below a configured RSRP; and a power of each of the PSFCHs or PSCCHs/PSSCHs that the UE would simultaneously transmit on the second carriers using the second P_{CMAX}, and if the total power for the PSFCHs and PSCCHs/PSSCHs transmissions would exceed the second P_{CMAX} the UE reduces the power for the PSCCH/PSSCH transmissions only, or reduces the powers of the PSCCH/PSSCH and PSFCH transmissions, based on a configuration by higher layers or an indication in a DCI format related to a physical channel priority or to a quality of the wireless channel determined by a measured RSRP being above or below a configured RSRP.

In one example the UE determines a power of each of the PSFCHs or PSCCHs/PSSCHs that the UE would simultaneously transmit on the first carriers using the first P_{CMAX}, a power of each of the PSFCHs or PSCCHs/PSSCHs that the UE would simultaneously transmit on the second carriers using the second P_{CMAX}, and if the total power over the first and second carriers would exceed the third P_{CMAX}, the UE reduces the power for the PSCCH/PSSCH transmissions only, or reduces the powers of the PSCCH/PSSCH and PSFCH transmissions.

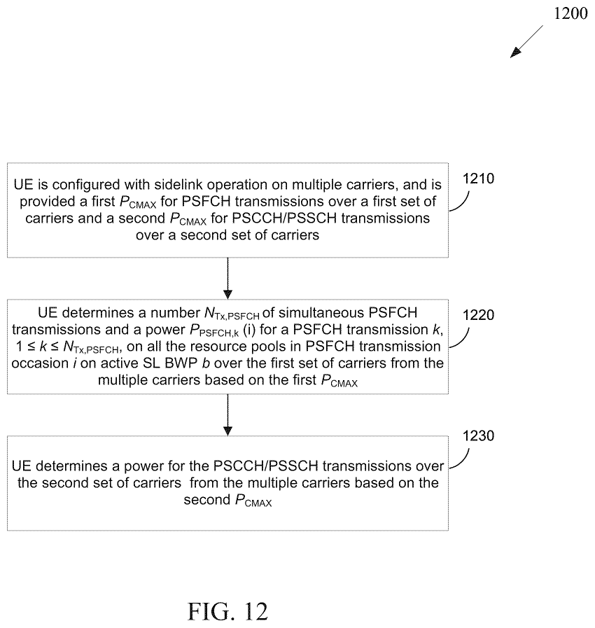

FIG. 12 illustrates a flowchart of a UE method 1200 for determining a power for a transmission of PSFCHs and PSCCHs/PSSCHs that overlap in a time domain over multiple carriers according to embodiments of the present disclosure. The UE method 1200 as may be performed by a UE (e.g., 111-116 as illustrated in FIG. 1). An embodiment of the UE method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

FIG. 12 illustrates an example procedure for a UE to determine a power for a transmission of PSFCHs and PSCCHs/PSSCHs that overlap in time over multiple carriers when the UE is provided a first P_{CMAX} for PSFCH transmissions over a first set of carriers and a second P_{CMAX} for PSCCH/PSSCH transmissions over a second set of carriers, according to the disclosure.

A UE is configured with SL operation on multiple carriers and is provided a first P_{CMAX} for PSFCH transmissions over a first set of carriers and a second P_{CMAX} for PSCCH/PSSCH transmissions over a second set of carriers 1210. The UE determines a number N_{Tx,PSFCH} of simultaneous PSFCH transmissions and a power P_{PSFCH,k}(i) for a PSFCH transmission k, 1≤k≤N_{Tx,PSFCH}, on all the resource pools in PSFCH transmission occasion i on active SL BWP b over the first set of carriers from the multiple carriers based on the first P_{CMAX} 1220. The UE determines a power for the PSCCH/PSSCH transmissions over the second set of carriers from the multiple carriers based on the second P_{CMAX} 1230.

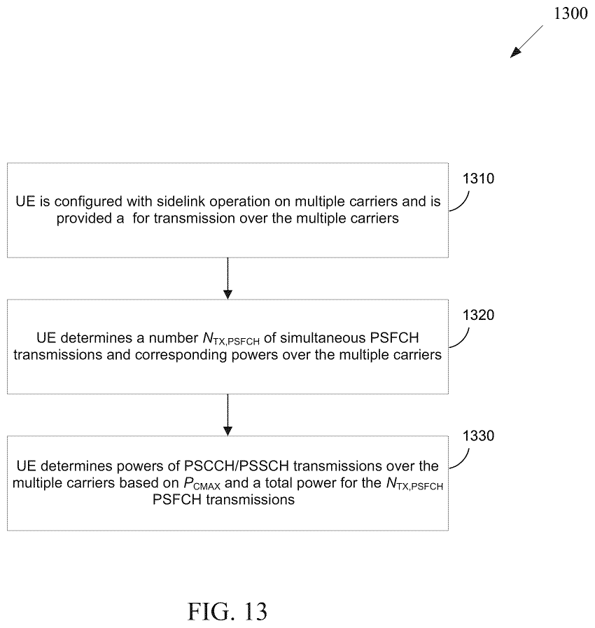

FIG. 13 illustrates a flowchart of a UE method 1300 to determine a power for a transmission of PSFCHs and PSCCHs/PSSCHs that overlap in time over multiple carriers when the UE is provided a P_{CMAX} according to embodiments of the present disclosure. The UE method 1300 as may be performed by a UE (e.g., 111-116 as illustrated in FIG. 1). An embodiment of the UE method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

When the UE is provided a first P_{CMAX} for a first set of carriers and a second P_{CMAX} for a second set of carriers, the procedure illustrated in FIG. 13 applies to each set of carriers. As illustrated in the method 1300, a UE is configured with SL operation on multiple carriers and is provided a P_{CMAX} for transmission over the multiple carriers 1310. The UE determines a number N_{Tx,PSFCH} of simultaneous PSFCH transmissions and corresponding powers over the multiple carriers 1320. The UE determines powers of PSCCH/PSSCH transmissions over the multiple carriers based on P_{CMAX} and a total power for the N_{Tx,PSFCH} PSFCH transmissions 1330.

When a UE is configured with SL operation on multiple carriers, and there is an overlap of PSFCH transmissions on N carriers, the UE with N_{sch,Tx,PSFCH} scheduled PSFCH transmissions for HARQ-ACK information and conflict information, and capable of transmitting a maximum of N_{max,PSFCH} PSFCHs over the N carriers, determines a number N_{Tx,PSFCH} of simultaneous PSFCH transmissions and a power P_{PSFCH,k}(i) for a PSFCH transmission k, 1≤k≤N_{Tx,PSFCH}, on all the resource pools in PSFCH transmission occasion i on active SL BWP b of each carrier f based on a P_{CMAX} determined for N_{sch,Tx,PSFCH} PSFCH transmissions from the descriptions in 3GPP standard specification TS 38.101-1, and according to the procedure described in 3GPP standard specification TS 38.213.

The PSFCH power control can be based on the pathloss between the gNB and the UE (i.e., the DL pathloss), or on the SL pathloss in order to avoid transmitting at a power larger than necessary, or on a combination of DL pathloss and SL pathloss, subject to a configuration and/or to a UE capability. The PSFCH power control parameters associated with the DL pathloss such as P_{O,PSFCH} which is a value of dl-P0-PSFCH, α_{PSFCH} which is a value of dl-Alpha-PSFCH can be configured for the multiple carriers, and the same configuration applies to the multiple carriers.

It is possible that the UE is configured with dl-P0-PSFCH and/or dl-Alpha-PSFCH per carrier, and the UE applies the procedure described in 3GPP standard specification TS 38.213 using the corresponding configurations for the PSFCHs scheduled on the different carriers. Thus, for each carrier f, the UE uses the corresponding value of P_{O,PSFCH,f} which is a value of dl-P0-PSFCH associated with carrier f, α_{PSFCH} which is a value of dl-Alpha-PSFCH associated with carrier f, and determines, when dl-P0-PSFCH is provided: P_{PSFCH,one,f}=P_{O,PSFCH,f}+10 log₁₀(2^{μ})+α_{PSFCH,f}. PL [dBm].

The path loss is also associated with the corresponding carrier f, wherein PL=PL_{b,f,c}(q_{d}) when the active SL BWP is on a serving cell c, as described in 3GPP standard specification TS 38.213 except that the RS resource is the one the UE uses for determining a power of a PUSCH transmission scheduled by a DCI format 0_0 in serving cell c when the UE is configured to monitor PDCCH for detection of DCI format 0_0 in serving cell c, and the RS resource is the one corresponding to the SS/PBCH block the UE uses to obtain MIB when the UE is not configured to monitor PDCCH for detection of DCI format 0_0 in serving cell c. Then the UE performs the following steps of the procedure as described in in 3GPP standard specification TS 38.213 using the determined P_{PSFCH,one,f} values for each carrier.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive information related to:
sidelink (SL) operation on multiple SL carriers, and
simultaneous transmissions of one or more physical sidelink feedback channels (PSFCHs) and one or more physical sidelink control or shared channels (PSCCHs or PSSCHs); and
a processor operably coupled to the transceiver, the processor configured to determine first powers and second powers for simultaneous transmissions of the one or more PSFCHs on first carriers and the one or more PSCCHs or PSSCHs on second carriers,
wherein the first powers are based on values of a first power control parameter associated with the first carriers,
wherein a sum of the second powers does not exceed a power difference between a maximum power and a sum of the first powers, and
wherein the transceiver is further configured to simultaneously transmit (i) the one or more PSFCHs on the first carriers using the first powers and (ii) the one or more PSCCHs or PSSCHs on the second carriers using the second powers.

2. The UE of claim 1, wherein, for each carrier, each of the first powers and the second powers does not exceed a maximum value.

3. The UE of claim 1, wherein at least one value of the first power control parameter associated with a carrier from the first carriers is different from values of the first power control parameter associated with remaining carriers from the first carriers.

4. The UE of claim 1, wherein:
the second powers are based on values of a second power control parameter associated with the second carriers, and
the first and second power control parameters are associated with one of:
a SL pathloss, or
a downlink (DL) pathloss.

5. The UE of claim 1, wherein the transceiver is further configured to receive information related to (i) the first power control parameter associated with transmissions of the one or more PSFCHs and (ii) a second power control parameter associated with transmissions of the one or more PSCCH or PSSCHs, per carrier or per beam.

6. The UE of claim 1, wherein the processor is further configured to:
determine third powers for transmission of the one or more PSCCHs or PSSCHs on the second carriers based on values of a second power control parameter associated with the second carriers, wherein a sum of the third powers exceeds the power difference; and
apply power reductions to one or more of the third powers based on a priority index associated with the one or more PSCCHs or PSSCHs.

7. The UE of claim 1, wherein the processor is further configured to:
determine third powers for transmissions of the one or more PSCCHs or PSSCHs based on values of a second power control parameter associated with the second carriers, wherein a sum of the third powers exceeds the power difference; and
determine whether to drop a transmission of a PSCCH or PSSCH on a carrier based on a pathloss associated with the carrier.

8. The UE of claim 1, wherein the transceiver is further configured to transmit the a PSCCH or PSSCH on a carrier of the second carriers using an initial power within a time interval.

9. The UE of claim 8, wherein the initial power is associated with a first PSCCH or PSSCH transmission occasion within the time interval.

10. The UE of claim 8, wherein, on a PSCCH or PSSCH transmission occasion within the time interval other than the first PSCCH or PSSCH transmission occasion, a sum of powers for transmissions of the PSCCHs or PSSCHs on carriers of the second carriers other than the carrier does not exceed the maximum power minus the sum of the first powers minus the initial power.

11. A method of user equipment (UE) in a wireless communication system, the method comprising:
receiving information related to:
sidelink (SL) operation on multiple SL carriers, and
simultaneous transmissions of one or more physical sidelink feedback channels (PSFCHs) and one or more physical sidelink control or shared channels (PSCCHs or PSSCHs);
determining first powers and second powers for simultaneous transmissions of the one or more PSFCHs on first carriers and the one or more PSCCHs or PSSCHs on second carriers,
wherein the first powers are based on values of a first power control parameter associated with the first carriers, and
wherein a sum of the second powers does not exceed a power difference between a maximum power and a sum of the first powers; and
simultaneously transmitting (i) the one or more PSFCHs on the first carriers using the first powers and (ii) the one or more PSCCHs or PSSCHs on the second carriers using the second powers.

12. The method of claim 11, wherein, for each carrier, each of the first powers and the second powers does not exceed a maximum value.

13. The method of claim 11, wherein at least one value of the first power control parameter associated with a carrier from the first carriers is different from values of the first power control parameter associated with remaining carriers from the first carriers.

14. The method of claim 11, wherein:
the second powers are based on values of a second power control parameter associated with the second carriers, and
the first and second power control parameters are associated with one of:
a SL pathloss, or
a downlink (DL) pathloss.

15. The method of claim 11, further comprising receiving information related to (i) the first power control parameter associated with transmissions of the one or more PSFCHs and (ii) a second power control parameter associated with transmissions of the one or more PSCCH or PSSCHs, per carrier or per beam.

16. The method of claim 11, further comprising:
determining third powers for transmission of the one or more PSCCHs or PSSCHs on the second carriers based on values of a second power control parameter associated with the second carriers, wherein a sum of the third powers exceeds the power difference; and
applying power reductions to one or more of the third powers based on a priority index associated with the one or more PSCCH or PSSCH.

17. The method of claim 11, further comprising:
determining third powers for transmissions of the one or more PSCCHs or PSSCHs based on values of a second power control parameter associated with the second carriers, wherein a sum of the third powers exceeds the power difference; and
determining whether to drop a transmission of a PSCCH or PSSCH on a carrier based on a pathloss associated with the carrier.

18. The method of claim 11, further comprising transmitting a PSCCH or PSSCH on a carrier of the second carriers using an initial power within a time interval.

19. The method of claim 18, wherein the initial power is associated with a first PSCCH or PSSCH transmission occasion within the time interval.

20. The method of claim 19, wherein, on a PSCCH or PSSCH transmission occasion within the time interval other than the first PSCCH or PSSCH transmission occasion, a sum of powers for transmissions of the PSCCH or PSSCH on carriers of the second carriers other than the carrier does not exceed the maximum power minus the sum of the first powers minus the initial power.
